(19) United States
(12) Patent Application Publication
(10) Pub. No.: US 2026/0299830 A1
(43) Pub. Date: Oct. 1, 2026

(54) STORAGE DEVICE

(71) Applicant: SAMSUNG ELECTRONICS CO., LTD., Suwon-si (KR)

(72) Inventors: Hyunsuk KANG, Suwon-si (KR); Sangyun KIM, Suwon-si (KR); Kyoungtae KANG, Suwon-si (KR); Jindo BYUN, Suwon-si (KR); Youngdon CHOI, Suwon-si (KR); Dongku KANG, Suwon-si (KR); Ji-Yoon PARK, Suwon-si (KR)

(73) Assignee: SAMSUNG ELECTRONICS CO., LTD., Suwon-si (KR)

(21) Appl. No.: 19/391,505

(22) Filed: Nov. 17, 2025

(30) Foreign Application Priority Data
Mar. 31, 2025 (KR) 10-2025-0041331

(51) Int. Cl. G06F 3/06

(52) U.S. Cl. CPC G06F 3/0658; G06F 3/061; G06F 3/0659; G06F 3/0679

(57) ABSTRACT

A storage device includes a storage controller including a first data pin and a plurality of first CA pins and a memory device including a memory cell array, a second data pin connected to the first data pin via a data bus, and a plurality of second CA pins connected to the plurality of first CA pins via a plurality of CA buses. The storage controller is configured to transmit a first command set to the memory device via a first CA bus among the plurality of CA buses, transmit a second command set to the memory device via a second CA bus among the plurality of CA buses, and transmit, in parallel, at least a portion of the first command set and at least a portion of the second command set such that transmission periods of the at least portions overlap with each other.

### CROSS-REFERENCE TO RELATED APPLICATION

This application claims priority to Korean Patent Application No. 10-2025-0041331, filed in the Korean Intellectual Property Office on Mar. 31, 2025, the entire contents of which are hereby incorporated by reference.

### BACKGROUND

### Field

The present disclosure relates to a storage device that includes a storage controller and a memory device.

### Description of Related Art

Semiconductor memory devices may be classified as volatile memory devices in which stored data disappears when power is removed, such as SRAM (Static RAM), DRAM (Dynamic RAM), and SDRAM (Synchronous DRAM), and non-volatile memory devices in which stored data is retained even when power is removed, such as ROM (Read Only Memory), PROM (Programmable ROM), EPROM (Electrically Programmable ROM), EEPROM (Electrically Erasable and Programmable ROM), flash memory devices, PRAM (Phase-change RAM), MRAM (Magnetic RAM), RRAM (Resistive RAM), and FRAM (Ferroelectric RAM).

### SUMMARY

The present disclosure pertains to a storage device that enhances data transmission and reception efficiency between a storage controller and a memory device.

The objects to be achieved by the present disclosure are not limited to those set forth above; other objects not expressly stated will be clearly understood by those of ordinary skill in the art from the following description of the disclosure.

In some embodiments, a storage device includes a storage controller including a first data pin and a plurality of first CA pins, and a memory device including a memory cell array, a second data pin connected to the first data pin via a data bus, and a plurality of second CA pins connected to the plurality of first CA pins via a plurality of CA buses. The storage controller is configured to transmit a first command set to the memory device via a first CA bus among the plurality of CA buses, transmit a second command set to the memory device via a second CA bus among the plurality of CA buses, and transmit, in parallel, at least a portion of the first command set and at least a portion of the second command set such that transmission periods of the at least portions of the first command set and the second command set overlap with each other.

In some embodiments, a storage device includes a storage controller, a first memory device including a first memory cell array, wherein the first memory device being connected to the storage controller via a data bus and a plurality of first CA buses, and a second memory device including a second memory cell array, wherein the second memory device being connected to the storage controller via the data bus and a plurality of second CA buses. The storage controller is configured to transmit a first command set to the first memory device via a (1-1)-th CA bus among the plurality of first CA buses, transmit a second command set to the first memory device via a (1-2)-th CA bus among the plurality of first CA buses, transmit, in parallel, at least a portion of the first command set and at least a portion of the second command set such that transmission periods of the at least portions overlap with each other, transmit a third command set to the second memory device via a (2-1)-th CA bus among the plurality of second CA buses, transmit, in parallel, at least a portion of the first command set and at least a portion of the third command set such that transmission periods of the at least portions overlap with each other, transmit a fourth command set to the second memory device via a (2-2)-th CA bus among the plurality of second CA buses, and transmit, in parallel, at least a portion of the third command set and at least a portion of the fourth command set such that transmission periods of the at least portions overlap with each other.

In some embodiments, a storage device includes a storage controller including a first data pin and a plurality of first CA pins, and a memory device including a memory cell array including a plurality of pages including a plurality of memory cells connected to word lines, a second data pin connected to the first data pin via a data bus, and a plurality of second CA pins connected to the plurality of first CA pins via a plurality of CA buses. The storage controller is configured to transmit, via a first CA bus among the plurality of CA buses, a first command set including a plurality of granularity commands configured to read a portion of a first page among the plurality of pages smaller than a page unit, and transmit, via a second CA bus among the plurality of CA buses, a second command set including a plurality of granularity commands configured to read a portion of a second page among the plurality of pages smaller than a page unit, and transmit, in parallel, at least portions of the first command set and the second command set such that transmission periods of the at least portions overlap with each other. The memory device includes a first command decoder configured to receive and decode commands via the first CA bus, and a second command decoder configured to receive and decode commands via the second CA bus. The memory device is further configured to transmit, to the storage controller, first data obtained by reading the portion of the first page among the plurality of pages based on the first command set, and transmit, to the storage controller, second data obtained by reading the portion of the second page among the plurality of pages based on the second command set.

According to various embodiments of the present disclosure, by simultaneously or temporally overlappingly transmitting a plurality of command sets through CA (command/address) buses in parallel, overall command transmission time may be reduced and command-processing efficiency and overall system performance may be improved.

According to various embodiments of the present disclosure, by rapidly accessing data smaller than a page unit through granularity read commands, it is possible to access data within a predictable time even in environments in which repetitive and frequent data requests occur (e.g., AI learning or inference) and to enhance overall operational efficiency.

According to various embodiments of the present disclosure, by decoding in parallel, through a plurality of CA buses, different commands (e.g., cell-read commands, status-read commands, data-output commands) within a single memory device, bottlenecks in the command-decoding process may be alleviated and unnecessary wait time may be reduced, thereby increasing overall I/O throughput.

According to various embodiments of the present disclosure, if each command decoder is configured to exclusively process a specific command type, the function of the decoder may be simplified and lightened, thereby reducing circuit area and power consumption while maintaining high-speed responsiveness and stable performance.

According to various embodiments of the present disclosure, even when a particular command decoder experiences a fault in the parallel-command structure using a plurality of command decoders and a plurality of CA buses, command processing may be continued through the remaining decoders, thus improving system reliability and fault tolerance.

The technical effects obtainable through the present disclosure are not limited to the effects described above. Technical effects not mentioned will be clearly understood by those of ordinary skill in the art from the description of the disclosure given below.

### BRIEF DESCRIPTION OF THE DRAWINGS

FIG. 1 is a block diagram illustrating a storage system according to some embodiments.

FIG. 2 is a block diagram illustrating signals transmitted and received within a storage device.

FIG. 3 is a diagram illustrating a non-volatile memory according to an embodiment of the present disclosure.

FIG. 4 is a perspective view illustrating a memory block according to an embodiment of the present disclosure.

FIG. 5 is a circuit diagram illustrating a memory block according to an embodiment of the present disclosure.

FIG. 6 is a block diagram illustrating a storage device.

FIG. 7 is a diagram illustrating an example in which command sets and data are transmitted and received using the storage device of FIG. 6.

FIG. 8 is a diagram illustrating an example of a detailed configuration of the command sets of FIG. 7.

FIG. 9 is a diagram illustrating another example in which command sets and data are transmitted and received using the storage device of FIG. 6.

FIG. 10 is a diagram illustrating, in greater detail, the structure of the storage device of FIG. 6.

FIG. 11, FIG. 12, FIG. 13 and FIG. 14 are timing diagrams illustrating various examples of command sets and data transmitted and received through the command/address and data signals of FIG. 10.

FIG. 15 is a diagram illustrating a storage device according to an embodiment of the present disclosure.

FIG. 16 is a timing diagram illustrating an example of command sets and data transmitted and received through the command/address and data signals of FIG. 15.

FIG. 17 is a diagram illustrating a storage device according to an embodiment of the present disclosure.

FIG. 18 and FIG. 19 are timing diagrams illustrating various examples of command sets and data transmitted and received through the command/address and data signals of FIG. 17.

### DETAILED DESCRIPTION

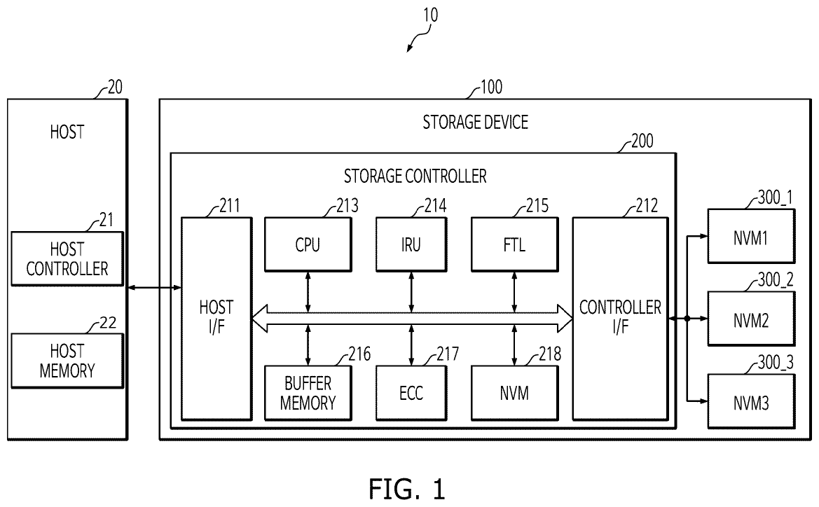

Hereinafter, various embodiments of the present disclosure will be described with reference to FIGS. 1 through 19. Like reference numerals throughout the specification may designate like elements.

FIG. 1 is a block diagram illustrating a storage system 10 according to some embodiments. Referring to FIG. 1, the storage system 10 may include a host 20 and a storage device 100.

In some embodiments, the host 20 may include a host controller 21 and a host memory 22. The host memory 22 may serve as a buffer memory for temporarily storing data to be transmitted to, or data transmitted from, the storage device 100.

According to an embodiment, the host controller 21 and the host memory 22 may be implemented as separate semiconductor chips. Alternatively, in some embodiments, the host controller 21 and the host memory 22 may be integrated on the same semiconductor chip. For example, the host controller 21 may be one of multiple modules included in an application processor, and the application processor may be implemented as a system-on-chip (SoC). Further, the host memory 22 may be an embedded memory within the application processor or a volatile memory or memory module disposed outside the application processor.

The host controller 21 may manage an operation of storing data (e.g., write data) from the host memory 22 in the non-volatile memory devices 300_1, 300_2 and 300_3, or storing data (e.g., read data) from the non-volatile memory devices 300_1, 300_2 and 300_3 in the host memory 22.

The storage device 100 may include a storage controller 200 and a plurality of non-volatile memory devices 300_1, 300_2 and 300_3. Although three non-volatile memory devices 300_1, 300_2 and 300_3 are illustrated in FIG. 1, the number is not limited thereto.

The storage device 100 may include a storage medium for storing data in response to a request from the host 20. For example, the storage device 100 may include at least one of a solid-state drive (SSD), an embedded memory, and a detachable external memory. Where the storage device 100 is an SSD, the storage device 100 may comply with the NVMe (Non-Volatile Memory Express) standard. Where the storage device 100 is an embedded or external memory, the storage device 100 may comply with the UFS (Universal Flash Storage) or eMMC (embedded Multi-Media Card) standard. The host 20 and the storage device 100 may each generate and transmit packets according to the adopted standard protocol.

When the non-volatile memory device 300_1, 300_2 and 300_3 includes flash memory, the flash memory may include a 2D NAND memory array or a 3D (vertical or bonding vertical) NAND (VNAND) memory array. In another example, the storage device 100 may further include various other types of non-volatile and/or volatile memory. For example, the storage device 100 may include at least one of SRAM, DRAM, SDRAM, ROM, PROM, EPROM, EEPROM, MRAM, spin-transfer-torque MRAM, conductive-bridging RAM (CBRAM), FeRAM, PRAM, and resistive RAM. At least some of the plurality of non-volatile memory devices (NVM) 300_1, 300_2 and 300_3 may alternatively be volatile memory devices.

The storage controller 200 may include a host interface 211, a controller interface circuit 212, and a central processing unit (CPU) 213. The storage controller 200 may further include an index read unit (IRU) 214, a flash translation layer (FTL) 215, a buffer memory 216, an error-correction-code (ECC) engine 217, and an internal non-volatile memory 218. The storage controller 200 may further include a working memory into which the flash translation layer 215 is loaded, and data write and read operations with respect to the non-volatile memory may be controlled by the CPU 213 executing the flash translation layer 215.

The host interface 211 may transmit and receive packets to and from the host 20. A packet transmitted from the host 20 to the host interface 211 may include a command and/or data to be written to the non-volatile memory devices 300_1, 300_2 and 300_3, and a packet transmitted from the host interface 211 to the host 20 may include a response to the command or data read from the non-volatile memory devices 300_1, 300_2 and 300_3. Although the host interface 211 is illustrated as being included in the storage controller 200, the host interface 211 is not limited thereto and may be disposed outside the storage controller 200.

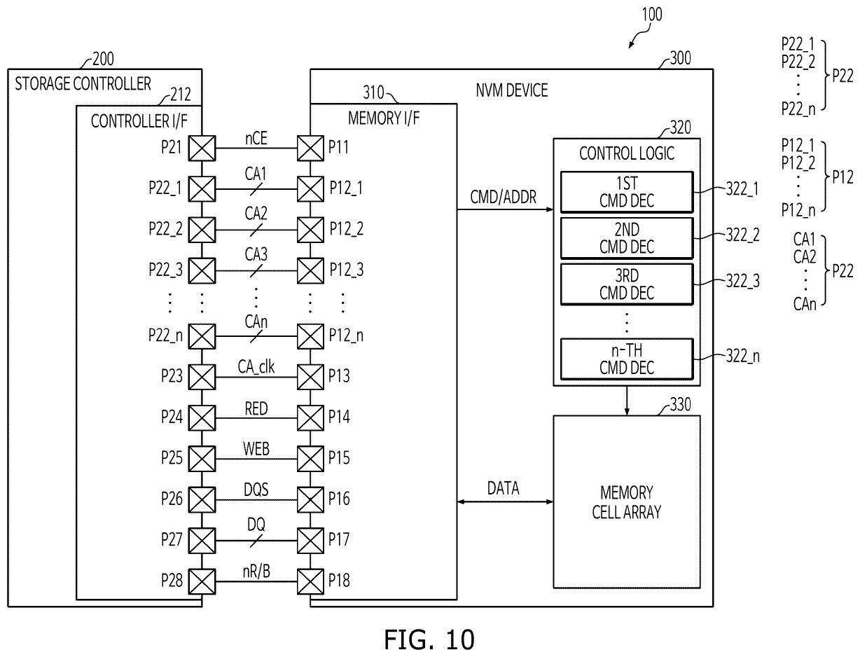

The controller interface circuit 212 may transmit data to be written to the non-volatile memory devices 300_1, 300_2 and 300_3, or may receive data read from the non-volatile memory devices 300_1, 300_2 and 300_3. According to various embodiments of the present disclosure, command/address transmission between the controller interface circuit 212 and each of the non-volatile memory devices 300_1, 300_2 and 300_3 may be performed in parallel via a plurality of CA buses, and by concurrently executing various command sets, command-processing efficiency may be greatly improved. Details will be described below with reference to FIGS. 10-19.

In an example, the index read unit 214 may efficiently read data corresponding to a mapping table (or index) from the non-volatile memory devices 300_1, 300_2 and 300_3 and provide the data to the CPU 213 or a DMA engine.

The flash translation layer 215 may perform various functions such as address mapping, wear leveling, and garbage collection. The buffer memory 216 may temporarily store data to be written to, or data read from, the non-volatile memory devices 300_1, 300_2 and 300_3. The buffer memory 216 may be provided within the storage controller 200, but may alternatively be disposed outside the storage controller 200.

The ECC engine 217 may perform error detection and correction on read data read from the non-volatile memory devices 300_1, 300_2 and 300_3. More specifically, the ECC engine 217 may generate parity bits for write data to be written into the non-volatile memory devices 300_1, 300_2 and 300_3, and the generated parity bits may be stored in the non-volatile memory devices 300_1, 300_2 and 300_3 together with the write data. When data is read from the non-volatile memory devices 300_1, 300_2 and 300_3, the ECC engine 217 may correct errors in the read data using the parity bits read together with the read data and output the error-corrected data.

The internal non-volatile memory 218 may store a plurality of defense-code parameter sets corresponding to each of the plurality of non-volatile memory devices 300_1, 300_2 and 300_3. In some embodiments, a defense-code parameter set may be one information set among a read-retry table, a word-line-specific read-retry table, a temperature-specific read-level-offset table, patrol-read information, erase/program operation voltage information that varies depending on endurance cycles, or a read-refresh table.

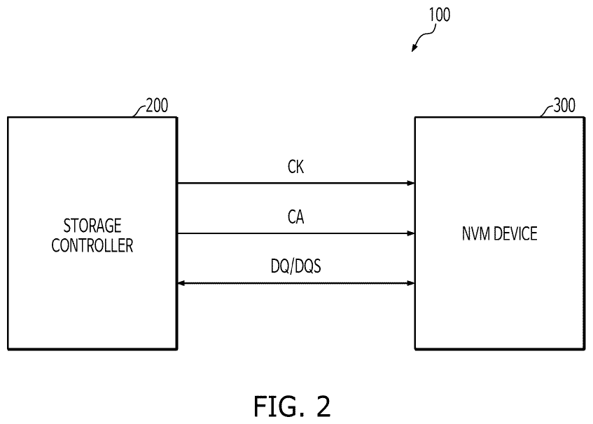

FIG. 2 is a block diagram illustrating signals transmitted and received within the storage device 100. The non-volatile memory device 300 may be any of the non-volatile memory devices 300_1, 300_2 and 300_3 of FIG. 1.

The storage controller 200 may transmit a clock signal CK and command/address signal CA to the non-volatile memory device 300, and may transmit and receive a data signal DQ and a data-strobe signal DQS to and from the non-volatile memory device 300.

The non-volatile memory device 300 may operate under the control of the storage controller 200. For example, the non-volatile memory device 300 may receive the clock signal CK and the command/address signal CA from the storage controller 200. The command/address signal CA may be delivered to the non-volatile memory device 300 via a CA bus separate from the data bus through which the data signal DQ is delivered. According to various embodiments of the present disclosure, by expanding the CA-bus configuration so that command and data signals may be transmitted in parallel between the storage controller 200 and the non-volatile memory device 300, high-speed operation and high concurrency may be provided. Details will be described below with reference to FIGS. 10-19.

In response to the received command/address signal CA, the non-volatile memory device 300 may transmit data to the storage controller 200 through the data signal DQ and the data-strobe signal DQS, or may receive data from the storage controller 200 through the data signal DQ and the data-strobe signal DQS. The data signal DQ and the data-strobe signal DQS may be transmitted and received through dedicated lines between the non-volatile memory device 300 and the storage controller 200. The data signal DQ may be transmitted from the storage controller 200 to the non-volatile memory device 300, or from the non-volatile memory device 300 to the storage controller 200.

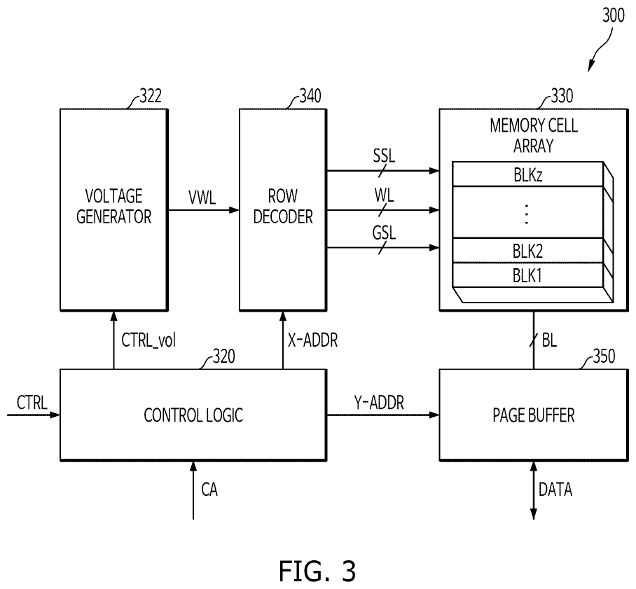

FIG. 3 is a diagram illustrating a non-volatile memory according to an embodiment of the present disclosure. The non-volatile memory device 300 may correspond to any one of the non-volatile memory devices 300_1, 300_2 and 300_3 of FIG. 1.

Referring to FIG. 3, the non-volatile memory device 300 may include a memory cell array 330, a voltage generator 322, control-logic circuitry 320, a row decoder 340, and a page-buffer circuit 350. In another embodiment, the non-volatile memory device 300 may further include a data I/O circuit or an I/O interface.

The memory cell array 330 may include a plurality of memory cells and may be connected to word lines WL, string-select lines SSL, ground-select lines GSL, and a plurality of bit lines BL. Specifically, the memory cell array 330 may be connected to the row decoder 340 through the word lines WL, the string-select lines SSL, and the ground-select lines GSL, and may be connected to the page-buffer circuit 350 through the plurality of bit lines BL.

The memory cell array 330 may include a plurality of memory blocks BLK1-BLKz. Each of the plurality of memory blocks BLK1-BLKz may include a plurality of pages connected to memory cells. One or more pages may be connected to each word line WL.

Each of the plurality of memory blocks BLK1-BLKz may have a three-dimensional (or vertical) structure. Specifically, each memory block may include structures elongated along first to third directions. For example, each memory block may include a plurality of NAND strings elongated along the third direction, the plurality of NAND strings being spaced apart from one another by a predetermined distance along the first and second directions.

The plurality of memory blocks BLK1-BLKz may be selected by the row decoder 340. For example, the row decoder 340 may select a memory block corresponding to a block address among the plurality of memory blocks BLK1-BLKz.

Each memory cell included in the memory cell array 330 may store at least one bit. In an embodiment, a memory cell may be a single-level cell (SLC) that stores one bit. In another embodiment, the memory cell may be a multi-level cell (MLC), such as a double-level-cell (DLC) that stores two bits, a triple-level cell (TLC) that stores three bits, or a quadruple-level cell (QLC) that stores four bits. The disclosure is not limited thereto.

The plurality of memory blocks BLK1-BLKz may include at least one of an SLC block including SLCs, an MLC block including MLCs, a TLC block including TLCs, or a QLC block including QLCs. For example, among the plurality of memory blocks BLK1-BLKz included in the memory cell array 330, some memory blocks may be SLC blocks, and other memory blocks may be MLC blocks, TLC blocks or QLC blocks.

When an erase voltage is applied to the memory cell array 330, the plurality of memory cells may become an erased state, and when a program voltage is applied to the memory cell array 330, the plurality of memory cells may become a programmed state. Each memory cell may have an erased state or at least one programmed state classified according to a threshold voltage. In other words, the states of the memory cells may include an erased state and at least one programmed state, and the specific state of each memory cell may be either the erased state or one of the programmed states.

The control-logic circuit 320 may generally control various operations within the non-volatile memory device 300. For example, based on the command/address signal CA and control signal CTRL, the control-logic circuit 320 may output various control signals for writing data to, or reading data from, the memory cell array 330. The control-logic circuit 320 may control a plurality of program operations for a plurality of pages. According to various embodiments of the present disclosure, even during program or read operations performed in the memory cell array 330, command parallel processing using a plurality of CA buses is possible, thereby efficiently reducing overall page-access time. Details will be described below with reference to FIGS. 10-19.

Various control signals output from the control-logic circuit 320 may be provided to the voltage generator 322, the row decoder 340, and the page-buffer circuit 350. For example, the control-logic circuit 320 may provide a voltage-control signal CTRL_vol to the voltage generator 322.

The voltage generator 322 may be connected to the memory cell array 330 through the plurality of word lines WL. Based on the voltage-control signal CTRL_vol, the voltage generator 322 may generate various voltages for performing program, read, and/or erase operations for the memory cell array 330. The voltage generator 322 may generate word-line voltages VWL, e.g., program, verify, read, and erase voltages.

The program, verify, read, and erase voltages generated by the voltage generator 322 may be provided to selected word lines among the plurality of word lines WL. The selected word line may be at least one word line selected by a row address X-ADDR. Each of the plurality of word lines WL includes a plurality of pages, and the program, verify, and read operations performed by the voltages generated by the voltage generator 322 may be performed on a page basis. For example, a program voltage (or pulse) and a verify voltage (or pulse) may be applied to a selected page within a selected word line, and program and verify operations for the selected page may thereby be performed.

During an erase operation, the voltage generator 322 may apply an erase voltage to a well and/or a common source line of a memory block. In addition, the voltage generator 322 may apply an erase-allow voltage (e.g., ground voltage) to all word lines of the memory block or to word lines corresponding to a partial sub-block based on an erase address. During an erase-verify operation, the voltage generator 322 may apply an erase-verify voltage to all word lines of one memory block or apply an erase-verify voltage on a word-line basis.

During a program operation, the voltage generator 322 may apply a program voltage to a selected word line among the plurality of word lines WL and apply a program-pass voltage to unselected word lines. During a program-verify operation, the voltage generator 322 may apply a program-verify voltage to the selected word line and apply a verify-pass voltage to the unselected word lines.

During a normal read operation, the voltage generator 322 may apply a read voltage to the selected word line and a read-pass voltage to the unselected word lines.

During a data-recovery read operation, the voltage generator 322 may apply a read-pass voltage to the selected word line and apply a read voltage to at least one word line adjacent to the selected word line. Alternatively, the voltage generator 322 may apply a read voltage to the selected word line and a read-pass voltage to at least one word line adjacent to the selected word line.

The row decoder 340 may select a specific word line among the word lines WL in response to the row address X-ADDR received from the control-logic circuit 320. Specifically, during a program operation, the row decoder 340 may provide a program voltage to the selected word line. The row decoder 340 may also select some of the string-select lines SSL or some of the ground-select lines GSL in response to the row address X-ADDR received from the control-logic circuit 320.

The page-buffer circuit 350 may be connected to the memory cell array 330 through the plurality of bit lines BL. The page-buffer circuit 350 may select some of the plurality of bit lines BL in response to a column address Y-ADDR received from the control-logic circuit 320. During a verify operation (e.g., an erase-verify or program-verify operation) or a read operation, the page-buffer circuit 350 may operate as a sense amplifier to sense data stored in selected memory cells through the selected bit lines. During a program operation, the page-buffer circuit 350 may operate as a write driver to input data to be stored in the memory cell array 330. The page-buffer circuit 350 may include a plurality of page buffers, each of which may be connected to at least one bit line.

The page-buffer circuit 350 may store data read from the memory cell array 330 or data to be stored in the memory cell array 330.

The page-buffer circuit 350 may include a plurality of page buffers each connected to each bit line. The plurality of page buffers may be arranged corresponding to respective bit lines, and each page buffer may include a plurality of latches. Hereinafter, the page-buffer circuit 350 is defined as including a page buffer connected to each bit line. However, the disclosed embodiments are not limited thereto; for example, a single page buffer may be provided corresponding to a plurality of bit lines, and a unit disposed corresponding to each bit line may be defined as a page-buffer unit. The page-buffer circuit 350 may temporarily store data to be programmed into a selected page during a program operation and temporarily store data read from a selected page during a read operation.

The control-logic circuit 320, the voltage generator 322, the row decoder 340, and the page-buffer circuit 350 may be included in peripheral circuits.

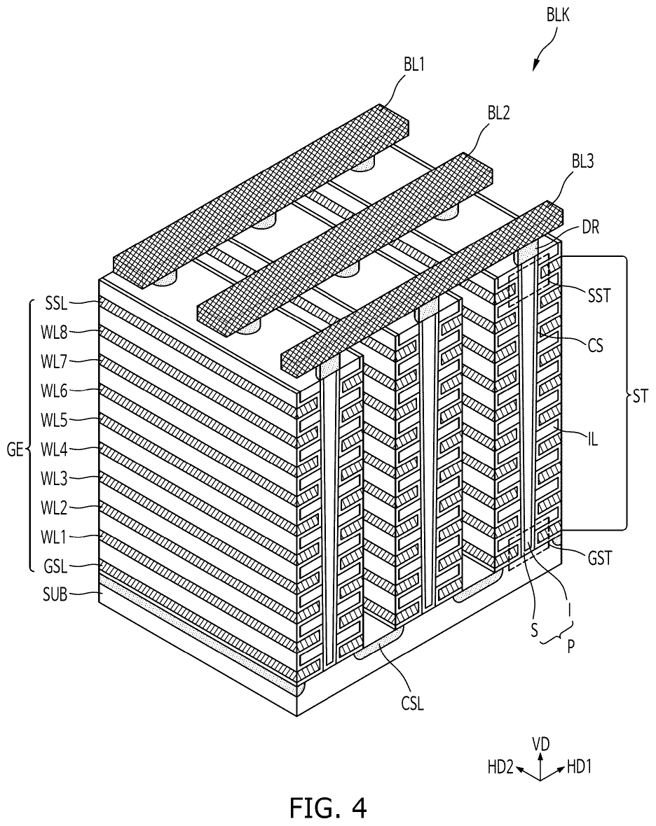

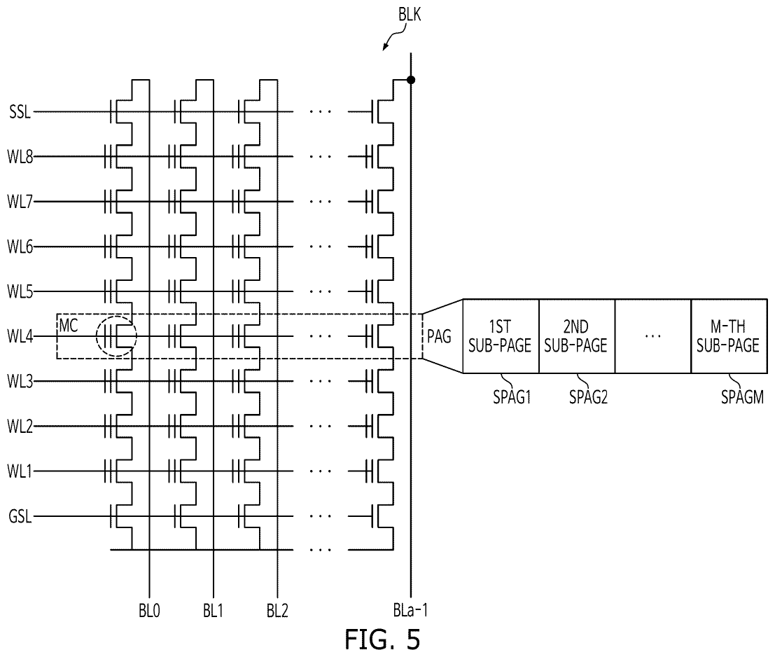

FIG. 4 is a perspective view illustrating a memory block according to an embodiment of the present disclosure, and FIG. 5 is a circuit diagram illustrating a memory block according to an embodiment of the present disclosure. The memory block BLK of FIGS. 4 and 5 may correspond to any one of the plurality of memory blocks BLK1-BLKz.

Referring to FIG. 4, the memory block BLK may include a stack ST extending in a vertical direction VD on an upper portion of a substrate SUB. For example, the memory block BLK may include a single stack ST between the substrate SUB and bit lines BL1, BL2 and BL3. A common-source line CSL may be disposed on the substrate SUB, and insulation layers IL extending in a second horizontal direction HD2 may be sequentially provided along the vertical direction VD on a region of the substrate SUB between adjacent common-source lines CSL, the insulation layers IL being spaced apart from one another by a predetermined distance along the vertical direction VD. Pillars P penetrating the insulation layers IL along the vertical direction VD may be provided on the region of the substrate SUB between adjacent common-source lines CSL. Each pillar P may be referred to as a channel hole. Each pillar P may be formed in a cup shape (or a capped cylindrical shape) extending in the vertical direction VD. A surface layer S of each pillar P may include a silicon material of a first type and may function as a channel region. An inner layer I of each pillar P may include an insulating material such as silicon oxide or an air gap.

In a region between adjacent common-source lines CSL, a charge-storage layer CS may be provided along the exposed surfaces of the insulation layers IL, the pillars P, and the substrate SUB. The charge-storage layer CS may include a gate-insulating layer, a charge-trap layer, and a blocking-insulating layer. For example, the charge-storage layer CS may have an ONO (oxide-nitride-oxide) structure. Further, in the region between adjacent common-source lines CSL, gate electrodes GE, such as select lines GSL, SSL and word lines WL1, WL2, WL3, WL4, WL5, WL6, WL7 and WL8, may be provided on the exposed surface of the charge-storage layer CS. Drains DR may be provided on the plurality of pillars P, respectively. Bit lines BL1, BL2 and BL3 extending in the first horizontal direction HD1 and spaced apart from one another by a predetermined distance along the second horizontal direction HD2 may be provided on the drains DR.

The memory block BLK may further include a string selection transistor SST and a ground selection transistor GST stacked along the vertical direction on the substrate SUB.

Referring to FIG. 5, the memory block BLK may include a plurality of pages PAG each composed of memory cells MC arranged in a direction perpendicular to each bit line BL0-BLa-1.

In a NAND flash-memory device having the structure of FIG. 5, erase operations are performed on a block basis, and program and read operations are performed on a page basis corresponding to each word line WL1, WL2, WL3, WL4, WL5, WL6, WL7 and WL8. FIG. 5 illustrates an example in which eight pages PAG corresponding to eight word lines WL1, WL2, WL3, WL4, WL5, WL6, WL7 and WL8 are provided in one block. However, the number of memory cells MC and pages PAG included in a memory block of the memory cell array 120 according to the embodiments of the disclosure may differ from those illustrated in FIG. 5.

According to various embodiments of the present disclosure, granular reads and parallel-command processing for a plurality of sub-pages SPAG1-SPAGM included in a page PAG may be performed. By performing granularity reads and parallel-command processing for the plurality of sub-pages SPAG1-SPAGM, the usability of the memory cell array may be enhanced and system performance may be improved. Details will be described below with reference to FIGS. 10-19.

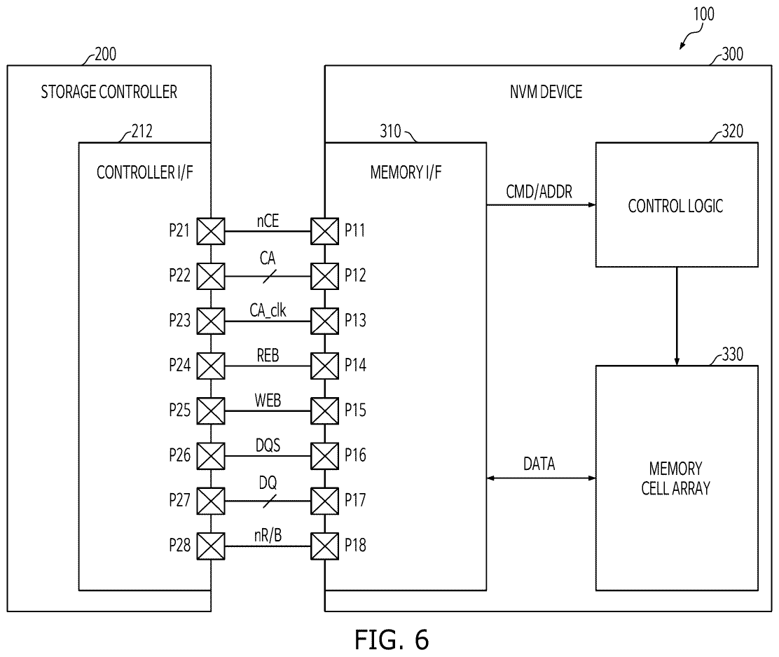

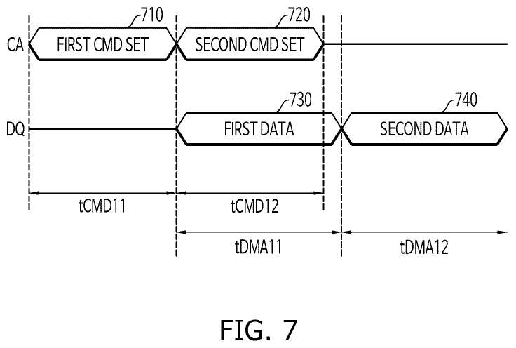

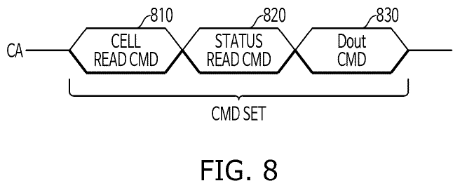

FIG. 6 is a block diagram illustrating the storage device 100, FIG. 7 is a diagram illustrating an example in which command sets 710 and 720 and data 730 and 740 are transmitted and received using the storage device 100 of FIG. 6, and FIG. 8 is a diagram illustrating an example of a detailed configuration of the command sets 710 and 720 of FIG. 7.

Referring to FIG. 6, the non-volatile memory device 300 of FIG. 6 may correspond to any one of the non-volatile memory devices 300_1, 300_2 and 300_3 illustrated and described with reference to FIG. 1. Here, the storage controller 200 and the non-volatile memory device 300 may communicate with each other using a separate-command/address (SCA) protocol.

The non-volatile memory device 300 may include first through eighth pins P11, P12, P13, P14, P15, P16, P17 and P18, a memory-interface circuit 310, a control-logic circuit 320, and a memory cell array 330. Descriptions of the control-logic circuit 320 and the memory cell array 330 with reference to FIG. 3 will be omitted.

The storage controller 200 may include first through eighth pins P21, P22, P23, P24, P25, P26, P27 and P28 and a controller-interface circuit 212. The first through eighth pins P21, P22, P23, P24, P25, P26, P27 and P28 of the storage controller 200 may correspond to the first through eighth pins P11, P12, P13, P14, P15, P16, P17 and P18 of the non-volatile memory device 300_1.

The controller-interface circuit 212 may transmit a chip-enable signal nCE to the non-volatile memory device 300_1 through a first pin P21, and the memory-interface circuit 310 may receive the chip-enable signal nCE from the storage controller 200 through a first pin P11. Among the plurality of memory devices connected, the controller-interface circuit 212 may transmit and receive signals through second through eighth pins P22, P23, P24, P25, P26, P27 and P28 with the non-volatile memory device 300_1 selected by the chip-enable signal nCE, and the memory-interface circuit 310 may transmit and receive signals with the storage controller 200 through second through eighth pins P12, P13, P14, P15, P16, P17 and P18 according to the chip-enable signal nCE. For example, where the chip-enable signal nCE is an enable state (e.g., low level), the memory-interface circuit 310 may transmit and receive signals with the storage controller 200 through second through eighth pins P12, P13, P14, P15, P16, P17 and P18.

The controller-interface circuit 212 may transmit a command/address signal CA and a command/address-clock signal CA_clk to the non-volatile memory device 300_1 through second and third pins P22 and P23, and the memory-interface circuit 310 may receive the same through second and third pins P12 and P13. In the SCA protocol, the command/address signal CA may be transmitted in place of conventional command-latch-enable signals (e.g., CLE) and address-latch-enable signals (e.g., ALE). The command/address signal CA may be transmitted through multiple pins. For example, the second pin P22 of the controller-interface circuit 212 may include multiple pins (e.g., two pins), and the second pin P12 of the memory-interface circuit 310 may include multiple pins (e.g., two pins) connected to the second pin P22 of the controller-interface circuit 212.

The memory-interface circuit 310 may receive a command CMD and an address ADDR from the storage controller 200. For example, the controller-interface circuit 212 may transmit a write-enable signal WEB to the memory-interface circuit 310 through a fifth pin P25, and the memory-interface circuit 310 may receive the write-enable signal WEB from the storage controller 200 through a fifth pin P15. The memory-interface circuit 310 may acquire the command CMD and/or the address ADDR through a second pin P12 in accordance with the command/address-clock signal CA_clk based on toggle timings of the write-enable signal WEB. In this specification, the second pin P12 of the memory-interface circuit 310 and the second pin P22 of the controller-interface circuit 212 may each be referred to as a “command/address (CA) pin” or “CA pin.” In addition, in this specification, a path through which the command CMD and the address ADDR are transmitted to the memory-interface circuit 310 (e.g., a path connecting the second pin P12 of the memory-interface circuit 310 to the second pin P22 of the controller-interface circuit 212) and a path through which the command/address-clock signal CA_clk is transmitted (e.g., a path connecting the third pin P13 of the memory-interface circuit 310 to the third pin P23 of the controller-interface circuit 212) may be referred to as a “command/address bus” or “CA bus.”

The controller-interface circuit 212 may transmit a read-enable signal REB through a fourth pin P14, and the memory-interface circuit 310 may receive the same through the fourth pin P14. In response to receiving the read-enable signal REB, the memory-interface circuit 310 may receive a data-strobe signal DQS from, or transmit the data-strobe signal DQS to, the storage controller 200 through a sixth pin P16.

The controller-interface circuit 212 may transmit a data signal DQ to, or receive the data signal DQ from, the non-volatile memory device 300_1 through a seventh pin P27. The memory-interface circuit 310 may receive the data signal DQ from, or transmit the data signal DQ to, the storage controller 200 through a seventh pin P17 based on toggle timings of the data-strobe signal DQS. That is, data DATA may be delivered through the data signal DQ.

For example, the data signal DQ may be delivered through a data bus connecting the seventh pin P17 of the memory-interface circuit 310 and the seventh pin P27 of the controller-interface circuit 212. The seventh pin P17 may include a plurality of pins (e.g., eight data pins) corresponding to a plurality of data signals.

In this specification, the seventh pin P17 of the memory-interface circuit 310 and the seventh pin P27 of the controller-interface circuit 212 may each be referred to as a “data pin” or “DQ pin.” In addition, in this specification, a path through which data DATA is transmitted between the memory-interface circuit 310 and the controller-interface circuit 212 (e.g., a path connecting the seventh pin P17 of the memory-interface circuit 310 to the seventh pin P27 of the controller-interface circuit 212) may be referred to as a “data bus.”

The memory-interface circuit 310 may transmit a ready/busy output signal nR/B to the storage controller 200 through an eighth pin P18, and the controller-interface circuit 212 may receive the same through an eighth pin P28. The memory-interface circuit 310 may transmit, through the ready/busy output signal nR/B, status information of the non-volatile memory device 300_1 to the storage controller 200.

Where the non-volatile memory device 300_1 is in a busy state (i.e., internal operations of the non-volatile memory device 300_1 are ongoing), the memory-interface circuit 310 may transmit a ready/busy output signal nR/B indicating the busy state to the storage controller 200. For example, while the non-volatile memory device 300_1 is programming data DATA into the memory cell array 330 in response to a program command or reading data DATA from the memory cell array 330 in response to a page-read command, the memory-interface circuit 310 may transmit a ready/busy output signal nR/B indicating the busy state to the storage controller 200.

Where the non-volatile memory device 300_1 is in a ready state (i.e., no internal operations of the non-volatile memory device 300_1 are being performed or operations are completed), the memory-interface circuit 310 may transmit a ready/busy output signal nR/B indicating the ready state to the storage controller 200.

The controller-interface circuit 212 may determine status information of the non-volatile memory device 300_1 based on the ready/busy output signal nR/B.

The control-logic circuit 320 may generally control various operations of the non-volatile memory device 300_1. The control-logic circuit 320 may receive the command/address CMD/ADDR acquired by the memory-interface circuit 310. The control-logic circuit 320 may generate control signals for controlling other components of the non-volatile memory device 300_1 according to the received command/address CMD/ADDR. For example, the control-logic circuit 320 may generate various control signals for programming data DATA to, or reading data DATA from, the memory cell array 330. In another example, the control-logic circuit 320 may generate control signals for adjusting channel potentials in the memory cell array.

The memory cell array 330 may store data DATA acquired from the memory-interface circuit 310 under control of the control-logic circuit 320. In this specification, the memory cell array 330 may output stored data DATA to the memory-interface circuit 310 under control of the control-logic circuit 320. Further, under control of the control-logic circuit 320, the memory cell array 330 may adjust channel potentials in the memory cell array.

The memory cell array 330 may include a plurality of memory cells. For example, the memory cells may be flash-memory cells. However, the disclosure is not limited thereto, and the memory cells may be RRAM cells, FRAM cells, PRAM cells, TRAM cells, or MRAM cells.

The controller-interface circuit 212 and the memory-interface circuit 310 illustrated and described with reference to FIG. 6 are exemplary and not limited thereto. For example, the controller-interface circuit 212 and the memory-interface circuit 310 may further include pins for transmitting and receiving signals different from those illustrated and described with reference to FIG. 6. In another example, among the plurality of pins P11, P12, P13, P14, P15, P16, P17 and P18 and P21, P22, P23, P24, P25, P26, P27 and P28 of the controller-interface circuit 212 and the memory-interface circuit 310, some pins may be omitted from, or integrated with, other pins.

Referring to FIGS. 6 and 7, the storage controller 200 may transmit a command/address signal CA including a first command set 710 and a second command set 720 to the memory device 300 via a CA bus connecting the second pin P12 of the memory-interface circuit 310 and the second pin P22 of the controller-interface circuit 212. The first command set 710 may be transmitted to the memory device 300 for a first time period (or first transmission period) tCMD11, and the second command set 720 may be transmitted to the memory device 300 for a second time period (or second transmission period) tCMD12.

Referring to FIGS. 7 and 8, the first command set 710 and the second command set 720 may each include a plurality of commands for reading a portion (e.g., one page) of the memory cell array 330. For example, the first command set 710 and the second command set 720 may each include a cell-read command tR command 810 for loading data from the memory cell array 330 to outside the memory cell array (e.g., the page-buffer circuit 350 of FIG. 3), a status-read command 820 for checking whether execution of the cell-read command has been completed, and a data-output command Dout command 830 for outputting data from the memory device 300 to the storage controller 200. The status-read command 820 may include a command transmitted from the storage controller 200 to the memory device 300 for checking a status of the memory device 300 and a response transmitted from the memory device 300 to the storage controller 200. Additionally, the first command set 710 and the second command set 720 may each include a LUNSel packet for selecting a logical-unit number, an SCE packet for starting or resuming a data burst (e.g., data I/O) through the data signal DQ, and an SCT packet for terminating the data burst.

In another example, the first command set 710 and the second command set 720 may each include a program command (e.g., an 80 h data-input command and a 10 h program-execute confirm command) for programming a specific page in the memory cell array 330.

Referring again to FIGS. 6 and 7, the memory device 300 may transmit, to the storage controller 200 through a data signal DQ via the data bus connecting the seventh pin P17 of the memory-interface circuit 310 and the seventh pin P27 of the controller-interface circuit 212, a data signal DQ including first data 730 obtained by reading a portion of the memory cell array 330 based on the received first command set 710. The memory device 300 may transmit, to the storage controller 200 through the data bus, a data signal DQ including second data 740 obtained by reading a portion of the memory cell array 330 based on the received second command set 720. The first data 730 may be transmitted to the storage controller 200 for a third time period (or third transmission period) tDMA11, and the second data 740 may be transmitted to the storage controller 200 for a fourth time period (or fourth transmission period) tDMA12.

For the memory device 300 to operate at high speed, a second time period tDMA11 during which the first data 730 is transmitted and received needs to be equal to or longer than a first time period tCMD11 during which the first command set 710 is transmitted and received, so that transmission of the next-in-order data may begin immediately after transmission of previously transmitted data is completed. Through this, it is possible to implement a high-performance memory device 300 that minimizes idle intervals of the data bus and improves overall I/O efficiency.

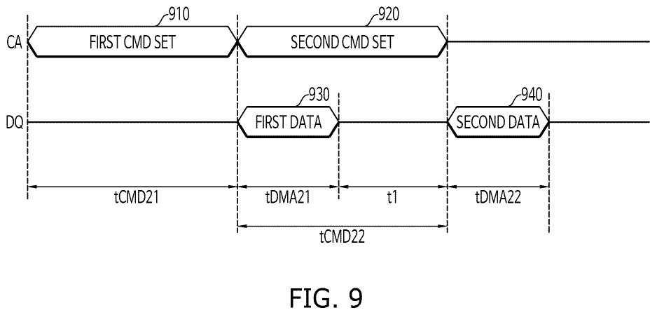

FIG. 9 is a diagram illustrating another example in which command sets 910 and 920 and data 930 and 940 are transmitted and received using the storage device 100 of FIG. 6.

Referring to FIGS. 6 and 9, the storage controller 200 may transmit a command/address signal CA including a first command set 910 and a second command set 920 to the memory device 300 via a CA bus connecting the second pin P12 of the memory-interface circuit 310 and the second pin P22 of the controller-interface circuit 212. The first command set 910 may be transmitted for a first time period tCMD21, and the second command set 920 may be transmitted for a first time period tCMD22.

Each of the first command set 910 and the second command set 920 may include a plurality of commands for reading a portion (e.g., any one of SPAG1-SPAGM of FIG. 5) of the memory cell array 330. For example, each of the plurality of commands included in the first command set 910 and the second command set 920 may be a granularity-read command for reading, in a size smaller than a page unit, a portion of one page (e.g., PAG of FIG. 5) among the plurality of pages in the memory cell array 330. Through this, the data read time is also dispersed into multiple pieces, thereby reducing the dispersion of the read time corresponding to each command set, and enhancing the consistency of data access time. For instance, in environments where repetitive data access at short intervals is required, such as in the learning process of an AI model (artificial intelligence model), this granularity-read method allows data access within a constant and predictable time in each read operation, improving the overall operating efficiency.

The memory device 300 may transmit, to the storage controller 200 through the data bus connecting the seventh pin P17 of the memory-interface circuit 310 and the seventh pin P27 of the controller-interface circuit 212, a data signal (DQ) including first data 930 obtained by reading a portion of the memory cell array 330 based on the received first command set 910. The memory device 300 may transmit, through the data bus, a data signal (DQ) including second data 940 obtained by reading a portion of the memory cell array 330 based on the received second command set 920. The first data 930 may be transmitted to the storage controller 200 for a third time period tDMA11, and the second data 940 may be transmitted to the storage controller 200 for a fourth time period tDMA12.

In FIG. 9, a time interval t1 between the first data 930 and the second data 940 may be a delay time from the point at which the transmission of the first data 930 is completed to the point just before the transmission of the second data 940 begins, representing unnecessary delays occurring between already transmitted and newly transmitted data between the storage controller 200 and the memory device 300. This may lower overall I/O efficiency and cause bottlenecks wherein periodic data requests quickly accumulate in environments requiring continuous and large-volume data access (e.g., AI model training). Further, in situations where granularity-read commands are frequently performed, internal preparation and page-buffer operations accompanying smaller-unit reads may aggravate the intermediate delay such that the time interval t1 is further extended. Accumulation of such delays may cause performance degradation until the overall system operating speed of the memory device 300 and the storage controller 200 approaches a limit, resulting in reduced effective throughput and latency.

FIG. 10 is a diagram illustrating, in greater detail, the structure of the storage device 100 of FIG. 6.

The controller-interface circuit 212 may include a plurality of second pins P22_1-P22_n (where n is an integer equal to or greater than two) and may transmit command/address signals CA1-CAn and a command/address-clock signal CA_clk to the non-volatile memory device 300 through the plurality of second pins P22_1-P22_n. The memory-interface circuit 310 may receive the command/address signals CA1-CAn through a plurality of second pins P12_1-P12_n.

Each of the plurality of second pins P22_1-P22_n of the controller-interface circuit 212 and each of the plurality of second pins P12_1-P12_n of the memory-interface circuit 310 may themselves include a plurality of pins (e.g., two pins). Although one command/address-clock signal CA_clk is illustrated in FIG. 10 as being transmitted to the non-volatile memory device 300, the command/address-clock signal CA_clk may include a plurality of command/address-clock signals each corresponding to one of the command/address signals CA1-CAn. A path through which any one of the command/address signals CA1-CAn and a command/address-clock signal corresponding to any one of the command/address signals CA1-CAn are transmitted may be referred to as a “CA bus.” For example, a first CA bus may be a path through which a first command/address signal CA1 and a command/address-clock signal corresponding to the first command/address signal CA1 are transmitted, and a second CA bus may be a path through which a second command/address signal CA2 and a command/address-clock signal corresponding to the second command/address signal CA2 are transmitted.

The memory device 300 may include a plurality of command decoders 322_1-322_n. Although the plurality of command decoders 322_1-322_n are illustrated as being included in the control-logic circuit 320, the disclosure is not limited thereto.

The plurality of command decoders 322_1-322_n may decode commands within the plurality of command/address signals CA1-CAn received through the plurality of CA buses. Each of the plurality of command decoders 322_1-322_n may receive a command through a corresponding CA bus among the plurality of CA buses. For example, the plurality of command decoders 322_1-322_n may include a first command decoder 322_1 that receives commands within the first command/address signal CA1 through a first CA bus, a second command decoder 322_2 that receives commands within the second command/address signal CA2 through a second CA bus, and a third command decoder 322_3 that receives commands within the third command/address signal CA3 through a third CA bus. In an example, the plurality of command decoders 322_1-322_n and the plurality of CA buses may have a one-to-one correspondence.

Based on the commands within the plurality of command/address signals CA1-CAn received through the plurality of CA buses, the plurality of command decoders 322_1-322_n may interpret which operation (e.g., a read operation, a program operation, an erase operation, etc.) a corresponding command corresponds to. Each of the plurality of command decoders 322_1-322_n may generate, based on the interpreted command, control signals for synchronously controlling internal circuits such as the memory cell array 330 and the page-buffer circuit 350 to perform an operation corresponding to the command. Additionally, each of the plurality of command decoders 322_1-322_n may track the flow of an operation composed of a plurality of commands and maintain intermediate-state information.

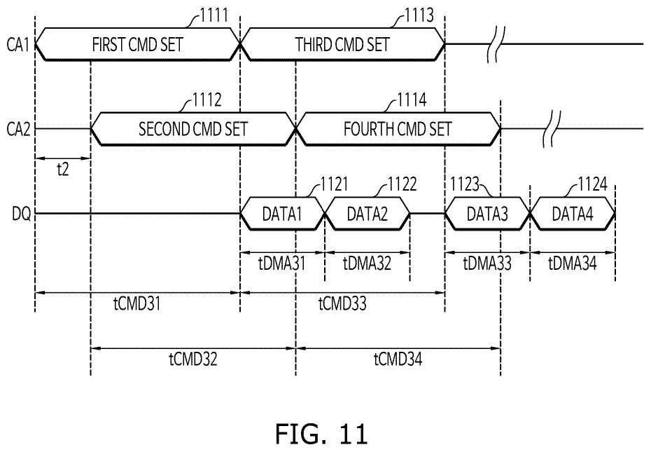

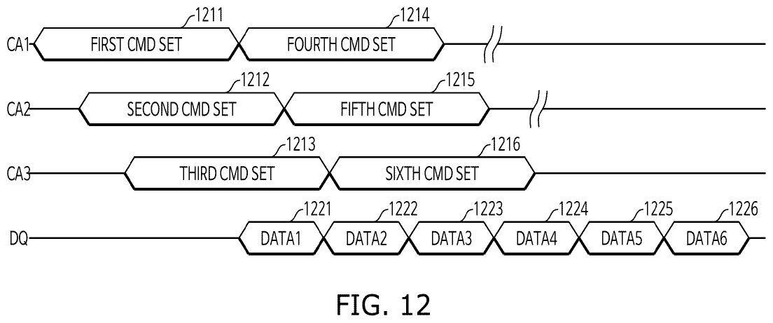

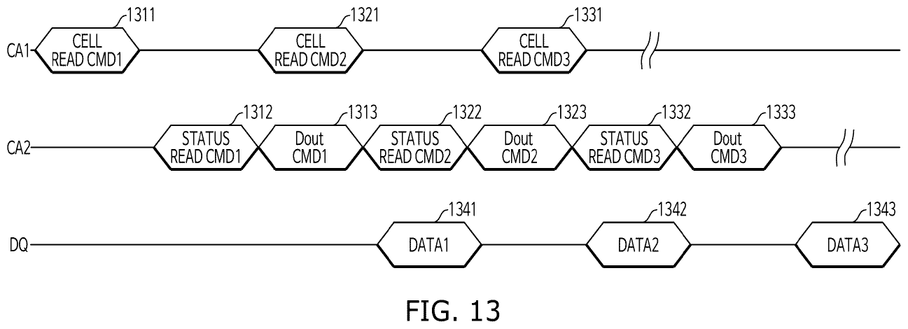

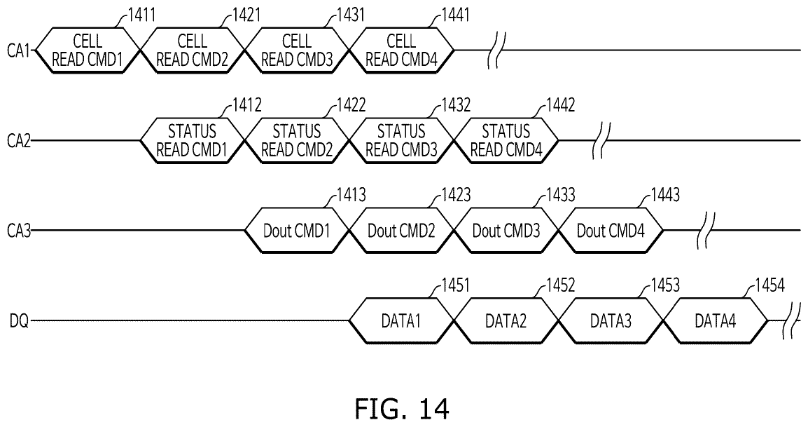

Hereinafter, with reference to FIGS. 11-14, types of commands transmitted and received in the form of the plurality of command/address signals CA1-CAn and operations of the plurality of command decoders 322_1-322_n will be described in detail.

FIGS. 11-14 are timing diagrams illustrating various examples of command sets and data transmitted and received through the command/address and data signals of FIG. 10.

Referring to FIGS. 10 and 11, the storage controller 200 may transmit a first command/address signal CA1 to the memory device 300 through a first CA bus among the plurality of CA buses and may transmit a second command/address signal CA2 to the memory device 300 through a second CA bus among the plurality of CA buses. The first command/address signal CA1 and the second command/address signal CA2 may include a plurality of command sets 1111, 1112, 1113 and 1114. For example, the storage controller 200 may transmit a first command set 1111 to the memory device 300 through the first CA bus and may transmit a second command set 1112 to the memory device 300 through the second CA bus.

Each of the command sets 1111, 1112, 1113 and 1114 may include a plurality of commands for reading a portion of the memory cell array 330. For example, each of the command sets 1111, 1112, 1113 and 1114 may include a granularity-read command for reading, in a size smaller than a page unit, a portion of one page among the plurality of pages.

In an embodiment, the storage controller 200 may transmit in parallel such that at least a portion of the transmission time period (or transmission period) of the first command set 1111 overlaps with at least a portion of the transmission time period of the second command set 1112. For example, the storage controller 200 may transmit the first command set 1111 at a first point in time and may transmit the second command set 1112 at a second point in time after a time (or a duration) t2 has elapsed from the first point in time. At the second point in time, the first command set 1111 may still be in transmission to the memory device 300. Similarly, the storage controller 200 may transmit in parallel such that at least a portion of the transmission time period of the second command set 1112 overlaps with at least a portion of the transmission time period of a third command set 1113 and such that at least a portion of the transmission time period of the third command set 1113 overlaps with at least a portion of the transmission time period of a fourth command set 1114.

Based on each of the received command sets 1111, 1112, 1113 and 1114, the memory device 300 may read a portion of a specific page among the plurality of pages, generate data, and transmit the generated data 1121, 1122, 1123 and 1124 to the storage controller 200 in the form of a data signal DQ through a data bus. For example, based on the first command set 1111, the memory device 300 may transmit first data 1121 obtained by reading a portion of a first page among the plurality of pages to the storage controller 200. Based on the second command set 1112, the memory device 300 may transmit second data 1122 obtained by reading a portion of a second page among the plurality of pages to the storage controller 200. Each of the data 1121, 1122, 1123 and 1124 generated by reading a portion of a specific page based on the command sets 1111, 1112, 1113 and 1114 may have a capacity smaller than that of data obtained by reading an entire specific page (e.g., 4,096 bytes), for example 512 bytes.

Referring to FIG. 11, the first command set 1111 may be transmitted from the storage controller 200 to the memory device 300 for a first time period tCMD31, the second command set 1112 for a second time period tCMD32, the third command set 1113 for a third time period tCMD33, and the fourth command set 1114 for a fourth time period tCMD34. The first data 1121 may be transmitted from the memory device 300 to the storage controller 200 for a fifth time period tDMA31, the second data 1122 for a sixth time period tDMA32, the third data 1123 for a seventh time period tDMA33, and the fourth data 1124 for an eighth time period tDMA34.

In an example, the fifth time period tDMA31, which is the transmission time of the first data 1121, may be equal to or greater than a time (or duration) t2 that is a difference between the points in time when transmission of the first command set 1111 and transmission of the second command set 1112 are initiated, so that immediately after the first data 1121 is completely transmitted to the storage controller 200, transmission of the second data 1122 may be initiated. Likewise, the seventh time period tDMA33, which is the transmission time of the third data 1123, may be equal to or greater than a difference between the points in time when transmission of the third command set 1113 and transmission of the fourth command set 1114 are initiated.

In an embodiment, a minimum value of the time t2, which is the difference between the points in time when transmission of the first command set 1111 and transmission of the second command set 1112 are initiated, may be zero, and a maximum value may be determined as a time such that delay time due to bottlenecks in data transmission and reception through the data signal DQ remains below a threshold.

Referring to FIGS. 10 and 12, compared with the embodiment described above with reference to FIG. 11, the storage controller 200 may utilize one more CA bus to transmit a plurality of command sets 1211, 1212, 1213, 1214, 1215 and 1216 to the memory device 300. For example, the storage controller 200 may further transmit a third command/address signal CA3 to the memory device 300 through a third CA bus among the plurality of CA buses. The first command/address signal CA1 may include a first command set 1211 and a fourth command set 1214, the second command/address signal CA2 may include a second command set 1212 and a fifth command set 1215, and the third command/address signal CA3 may include a third command set 1213 and a sixth command set 1216.

Each of the command sets 1211, 1212, 1213, 1214, 1215 and 1216 may include a plurality of commands for reading a portion of the memory cell array 330. For example, each of the command sets 1211, 1212, 1213, 1214, 1215 and 1216 may include a granularity-read command for reading, in a size smaller than a page unit, a portion of one page among the plurality of pages.

In an embodiment, the storage controller 200 may transmit in parallel such that a transmission time period of a command set transmitted through one of the plurality of CA buses overlaps with a transmission time period of a command set transmitted through another one of the plurality of CA buses. For example, the storage controller 200 may transmit in parallel such that at least a portion of the transmission time period of the first command set 1211 overlaps with at least a portion of the transmission time period of the second command set 1212, and may transmit in parallel such that at least a portion of the transmission time period of the third command set 1213 overlaps with the transmission time period of at least a portion of the first command set 1211 and/or at least a portion of the second command set 1212.

Based on each of the received command sets 1211, 1212, 1213, 1214, 1215 and 1216, the memory device 300 may read a portion of a specific page among the plurality of pages, generate data, and transmit the generated data 1221, 1222, 1223, 1224, 1225 and 1226 to the storage controller 200 in the form of a data signal DQ through the data bus.

In an embodiment, the storage controller 200 may transmit the first command set 1211 at a first point in time, transmit the second command set 1212 at a second point in time after a first time (or first duration) has elapsed from the first point in time, and transmit the third command set 1213 at a third point in time after a second time (or second duration) has elapsed from the second point in time. The memory device 300 may transmit, to the storage controller 200, first data 1221 obtained by reading a portion of a first page among the plurality of pages based on the first command set 1211, second data 1222 obtained by reading a portion of a second page among the plurality of pages based on the second command set 1212, and third data 1223 obtained by reading a portion of a third page among the plurality of pages based on the third command set 1213. Here, a third time (or third duration), which is the transmission time period of the first data 1221, may be equal to or greater than the first time (or first duration), and a fourth time (or fourth duration), which is the transmission time period of the second data 1222, may be equal to or greater than the second time (or second duration).

Referring to FIGS. 10-12, each of the command sets 1111, 1112, 1113 and 1114 of FIG. 11 and the command sets 1211, 1212, 1213, 1214, 1215 and 1216 of FIG. 12 may include the cell-read command, the status-read command, and the data-output command described above with reference to FIG. 8. Each of the plurality of command decoders 322_1-322_n of FIG. 10 may be configured so that decoding of a cell-read command, a status-read command, and/or a data-output command within one command set is possible.

For example, where the first command set 1111 includes a first cell-read command, a first status-read command, and a first data-output command, and the second command set 1112 includes a second cell-read command, a second status-read command, and a second data-output command, the first command decoder 322_1 may be configured to decode the first cell-read command, the first status-read command, and the first data-output command, and the second command decoder 322_2 may be configured to decode the second cell-read command, the second status-read command, and the second data-output command. In this way, decoding of commands may be performed in parallel using the command decoders 322_1-322_n, thereby improving command-processing speed, preventing decoding bottlenecks, and dispersing loads between channels so that stable performance may be maintained even during high-speed operation. Further, even when a particular command decoder is faulty, the same type of command may be processed through the remaining decoders, thus improving system reliability and fault tolerance.

In an embodiment different from the embodiment described above, each of the command sets 1111, 1112, 1113 and 1114 and 1211, 1212, 1213, 1214, 1215 and 1216 illustrated and described with reference to FIGS. 11 and 12 may include a plurality of commands for writing data to a portion of the memory cell array 330. In this case, the data 1121, 1122, 1123 and 1124 and 1221, 1222, 1223, 1224, 1225 and 1226 of FIGS. 11 and 12 may be data to be written to the memory cell array 330 and may be transmitted from the storage controller 200 to the memory device 300.

Referring to FIGS. 10 and 13, a command set delivered to the memory device 300 through a first CA bus using a first command/address signal CA1 may include a first cell-read command 1311, a second cell-read command 1321, and a third cell-read command 1331. A command set delivered to the memory device 300 through a second CA bus using a second command/address signal CA2 may include a first status-read command 1312, a first data-output command 1313, a second status-read command 1322, a second data-output command 1323, a third status-read command 1332, and a third data-output command 1333. The commands may be transmitted in parallel such that at least a portion of the transmission time(or, transmission period) of the command set delivered through the first CA bus using the first command/address signal CA1 overlaps with at least a portion of the transmission time of the command set delivered through the second CA bus using the second command/address signal CA2.

The memory device 300 may transmit data 1341-1343 to the storage controller 200 through the data bus using the data signal DQ. For example, based on the first data-output command 1313, the memory device 300 may transmit first data 1341 to the storage controller 200. Based on the second data-output command 1323, the memory device 300 may transmit second data 1342 to the storage controller 200. Based on the third data-output command 1333, the memory device 300 may transmit third data 1343 to the storage controller 200.

Each of the plurality of command decoders 322_1-322_n of FIG. 10 may be configured so that decoding of a cell-read command, a status-read command, and/or a data-output command is possible. For example, the first command decoder 322_1 may decode the cell-read commands 1311, 1321, 1331 transmitted through the first CA bus, and the second command decoder 322_2 may decode the status-read commands 1312, 1322, 1332 and data-output commands 1313, 1323, 1333 transmitted through the second CA bus.

Referring to FIGS. 10 and 14, a command set delivered to the memory device 300 through a first CA bus using a first command/address signal CA1 may include a first cell-read command 1411, a second cell-read command 1421, a third cell-read command 1431, and a fourth cell-read command 1441. A command set delivered to the memory device 300 through a second CA bus using a second command/address signal CA2 may include first through fourth status-read commands 1412, 1422, 1432, 1442. A command set delivered to the memory device 300 through a third CA bus using a third command/address signal CA3 may include first through fourth data-output commands 1413, 1423, 1433, 1443.

Commands may be transmitted in parallel such that at least a portion of the transmission time of the command set delivered through the first CA bus using the first command/address signal CA1 and at least a portion of the transmission time of the command set delivered through the second CA bus using the second command/address signal CA2 overlap with each other. Commands may be transmitted in parallel such that at least a portion of the transmission time of the command set delivered through the second CA bus using the second command/address signal CA2 and at least a portion of the transmission time of the command set delivered through the third CA bus using the third command/address signal CA3 overlap with each other. Commands may be transmitted in parallel such that at least a portion of the transmission time of the command set delivered through the first CA bus using the first command/address signal CA1 and at least a portion of the transmission time of the command set delivered through the third CA bus using the third command/address signal CA3 overlap with each other.

The memory device 300 may transmit, to the storage controller 200 through the data signal DQ using the data bus, data 1451, 1452, 1453, and 1454. For example, based on the first data-output command 1413, the memory device 300 may transmit first data 1451 to the storage controller 200. Based on the second data-output command 1423, the memory device 300 may transmit second data 1452 to the storage controller 200. Based on the third data-output command 1433, the memory device 300 may transmit third data 1453 to the storage controller 200. Based on the fourth data-output command 1443, the memory device 300 may transmit fourth data 1454 to the storage controller 200.

Each of the plurality of command decoders 322_1-322_n of FIG. 10 may be configured so that decoding of a cell-read command, a status-read command, or a data-output command is possible. For example, the first command decoder 322_1 may decode the cell-read commands 1411, 1421, 1431, 1441 transmitted through the first CA bus. The second command decoder 322_2 may decode the status-read commands 1412, 1422, 1432, 1442 transmitted through the second CA bus. The third command decoder 322_3 may decode the data-output commands 1413, 1423, 1433, 1443 transmitted through the third CA bus.

The embodiments illustrated and described with reference to FIGS. 13 and 14 are merely examples and are not limited thereto. For example, where a plurality of commands (e.g., four or more commands) are required to read, in a size smaller than a page unit, a portion of one page among the plurality of pages, each of the plurality of command decoders 322_1-322_n of FIG. 10 may be configured in various combinations so that decoding of a part of the plurality of commands is possible.

According to the embodiments described with reference to FIGS. 13 and 14, since each of the command decoders 322_1-322_n is configured to exclusively operate for a specific command type, the functions of the command-decoder circuits are simplified, thereby reducing an overall circuit area. Accordingly, both a volume of the memory device and power consumption may be reduced. In addition, since command classification is predetermined, decoding may be efficiently performed, and a lightweight decoder design optimized for dedicated commands may be achieved, thereby simultaneously ensuring high-speed responsiveness and low-power characteristics.

According to the embodiments described with reference to FIGS. 11-14, by increasing the number of CA pins and transmitting command/address signals CA in parallel, command transmission time may be shortened. When bandwidth of the CA bus is expanded, identical command-set data may be transmitted in a shorter time, so that a command-transmission interval preceding data transmission may be reduced. As a result, idle time between data transmissions may be reduced, which minimizes idle time on the data bus and contributes to improving overall I/O efficiency. Particularly, in a structure in which command transmission is repeatedly performed, such as a granularity-read method, command-preparation delay may be suppressed by parallel transmission, and the flow of continuous data processing may be maintained more smoothly.

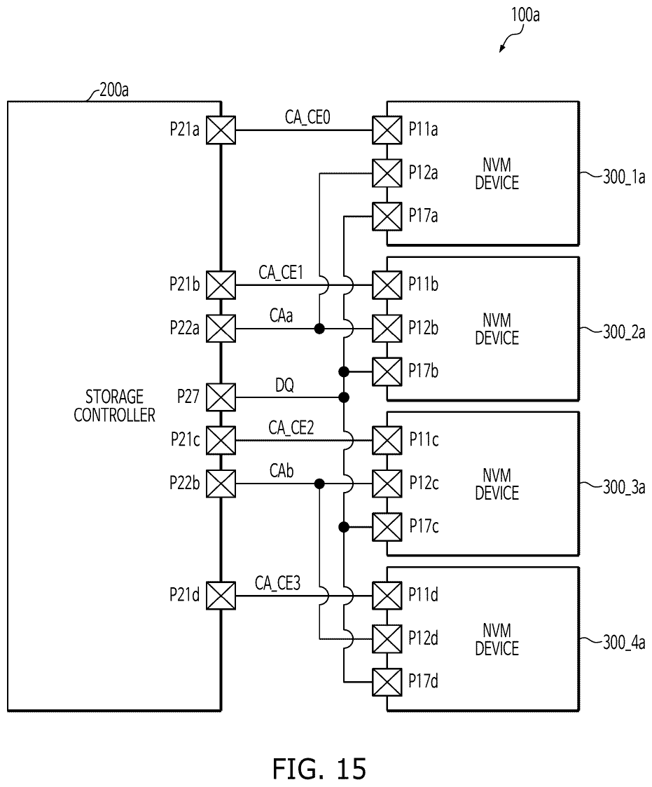

FIG. 15 is a diagram illustrating a storage device 100a according to an embodiment of the present disclosure. FIG. 15 schematically illustrates a structure in which a plurality of command sets are transmitted and a data signal DQ is transmitted and received between a storage controller 200a and first through fourth memory devices 300_1a, 300_2a, 300_3a and 300_4a using command/address signals CAa and CAb and chip-enable signals CA_CE0, CA_CE1, CA_CE2 and CA_CE3.

Referring to FIG. 15, the storage controller 200a may transmit a first command/address signal CAa to first and second memory devices 300_1a and 300_2a and may transmit a second command/address signal CAb to third and fourth memory devices 300_3a and 300_4a, thereby transmitting a plurality of command sets.

As illustrated, the plurality of memory devices 300_1a, 300_2a, 300_3a and 300_4a may transmit and receive a data signal DQ with the storage controller 200a through a single data bus. The first and second memory devices 300_1a and 300_2a may share one CA bus. The first or second memory device 300_1a or 300_2a may receive the first command/address signal CAa from the storage controller 200a through the CA bus. The third and fourth memory devices 300_3a and 300_4a may share one CA bus. The third or fourth memory device 300_3a or 300_4a may receive the second command/address signal CAb from the storage controller 200a through the CA bus.

The storage controller 200a may transmit a command set to a memory device among the plurality of memory devices 300_1a, 300_2a, 300_3a and 300_4a whose chip-enable signal CA_CE0, CA_CE1, CA_CE2 and CA_CE3 is active. The chip-enable signals CA_CE0, CA_CE1, CA_CE2 and CA_CE3 may act as selection signals for activating or deactivating each memory device between the storage controller 200a and the plurality of memory devices 300_1a, 300_2a, 300_3a and 300_4a. Through this, a command/address signal CAa or CAb delivered to a specific memory device may be transmitted in parallel without conflict.

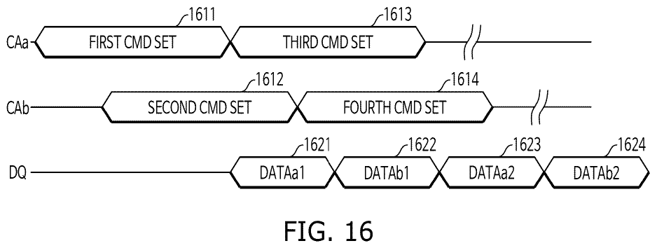

FIG. 16 is a timing diagram illustrating an example of command sets and data transmitted and received through the command/address and data signals of FIG. 15. Referring to FIG. 16, while a first command set 1611 is transmitted through the first command/address signal CAa, a second command set 1612 may be transmitted in parallel through the second command/address signal CAb. Thereafter, third and fourth command sets 1613 and 1614 may likewise be transmitted in parallel.

Referring to FIGS. 15 and 16, when preparation for reading or programming data in the first memory device 300_1a or second memory device 300_2a is completed according to the first command set 1611, the storage controller 200a may transmit and receive first data 1621 with the first memory device 300_1a or second memory device 300_2a through the data bus. When preparation for reading or programming data in the third memory device 300_3a or fourth memory device 300_4a is completed according to the second command set 1612, the storage controller 200a may transmit and receive second data 1622 with the third memory device 300_3a or fourth memory device 300_4a through the data bus. Similarly, the storage controller 200a and the plurality of memory devices 300_1a, 300_2a, 300_3a and 300_4a may transmit and receive third data 1623 and fourth data 1624.

According to the embodiment illustrated and described with reference to FIGS. 15 and 16, while data are transmitted and received sequentially without overlapping on a time axis, the command sets may be transmitted and received in parallel. By performing transmission of the plurality of command sets such that the transmissions overlap each other in time (i.e., in parallel), command-processing bandwidth may be widened compared with a conventional single-serial-transmission method, and overall efficiency of data transmission and reception between the storage controller 200a and the plurality of memory devices 300_1a, 300_2a, 300_3a and 300_4a may be improved. Particularly, by reducing wait time occurring during operations of the memory cell array and by sequentially interleaving commands (e.g., program, read) among the plurality of memory devices 300_1a, 300_2a, 300_3a and 300_4a, overall performance of the storage device 100a may be improved.

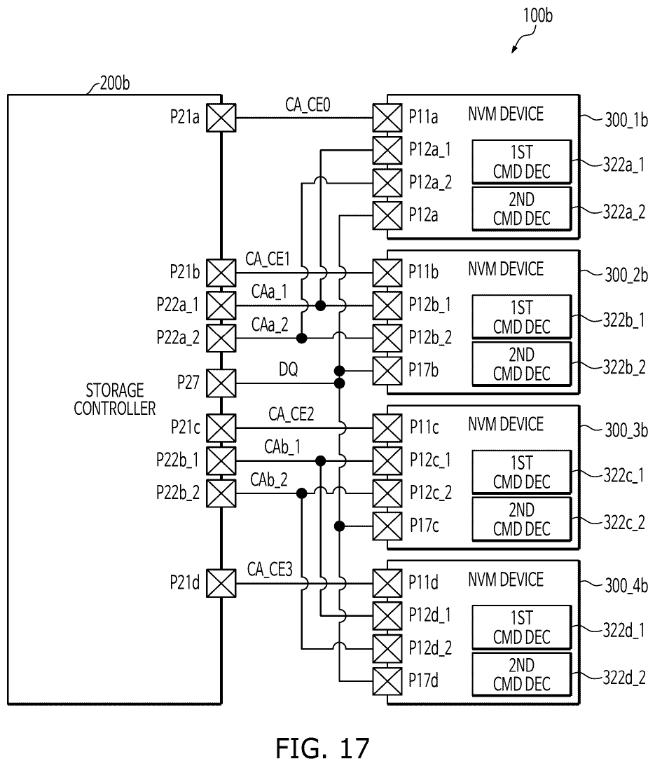

FIG. 17 is a diagram illustrating a storage device 100b according to an embodiment of the present disclosure. FIG. 17 may be a modified example of the storage device 100a of FIG. 15. For example, a storage controller 200b of FIG. 17 may correspond to the storage controller 200a of FIG. 15, and first through fourth memory devices 300_1b, 300_2b, 300_3b and 300_4b of FIG. 17 may correspond to the first through fourth memory devices 300_1a, 300_2a, 300_3a and 300_4a of FIG. 15. Descriptions of a detailed configuration of the storage device 100b of FIG. 17 corresponding to a detailed configuration of the storage device 100a of FIG. 15 will be omitted.

The first memory device 300_1b may include a first memory cell array and may be connected to the storage controller 200b via a data bus and a plurality of first CA buses. The first memory device 300_1b may transmit and receive a data signal DQ with the storage controller 200b via the data bus and may receive first command/address signals CAa_1 and CAa_2 through pins P12a_1 and P12a_2 connected to the plurality of first CA buses from the storage controller 200b. The first memory device 300_1b may include a plurality of first command decoders 322a_1 and 322a_2 configured to decode commands received through the plurality of first CA buses. Each of the plurality of first command decoders 322a_1 and 322a_2 may receive commands through a corresponding CA bus among the plurality of first CA buses. For example, a (1-1)-th command decoder 322a_1 may receive commands within a (1-1)-th command/address signal CAa_1 through the pin P12a_1, and a (1-2)-th command decoder 322a_2 may receive commands within a (1-2)-th command/address signal CAa_2 through the pin P12a_2.

The second memory device 300_2b may include a second memory cell array and may be connected to the storage controller 200b via the data bus and the plurality of first CA buses. The second memory device 300_2b may transmit and receive the data signal DQ with the storage controller 200b via the data bus and may receive the first command/address signals CAa_1 and CAa_2 through pins P12b_1 and P12b_2 connected to the plurality of first CA buses from the storage controller 200b. The second memory device 300_2b may include a plurality of second command decoders 322b_1 and 322b_2 configured to decode commands received through the plurality of first CA buses. Each of the plurality of second command decoders 322b_1 and 322b_2 may receive commands through a corresponding CA bus among the plurality of first CA buses. For example, a (2-1)-th command decoder 322b_1 may receive commands within the (1-1)-th command/address signal CAa_1 through the pin P12b_1, and a (2-2)-th command decoder 322b_2 may receive commands within the (1-2)-th command/address signal CAa_2 through the pin P12b_2.

The third memory device 300_3b may include a third memory cell array and may be connected to the storage controller 200b via the data bus and a plurality of second CA buses. The third memory device 300_3b may transmit and receive the data signal DQ with the storage controller 200b via the data bus and may receive second command/address signals CAb_1 and CAb_2 through pins P12c_1 and P12c_2 connected to the plurality of second CA buses from the storage controller 200b. The third memory device 300_3b may include a plurality of third command decoders 322c_1 and 322c_2 configured to decode commands received through the plurality of second CA buses. Each of the plurality of third command decoders 322c_1 and 322c_2 may receive commands through a corresponding CA bus among the plurality of second CA buses. For example, a (3-1)-th command decoder 322c_1 may receive commands within a (2-1)-th command/address signal CAb_1 through the pin P12c_1, and a (3-2)-th command decoder 322c_2 may receive commands within a (2-2)-th command/address signal CAb_2 through the pin P12c_2.

The fourth memory device 300_4b may include a fourth memory cell array and may be connected to the storage controller 200b via the data bus and the plurality of second CA buses. The fourth memory device 300_4b may transmit and receive the data signal DQ with the storage controller 200b via the data bus and may receive the second command/address signals CAb_1 and CAb_2 through pins P12d_1 and P12d_2 connected to the plurality of second CA buses from the storage controller 200b. The fourth memory device 300_4b may include a plurality of fourth command decoders 322d_1 and 322d_2 configured to decode commands received through the plurality of second CA buses. Each of the plurality of fourth command decoders 322d_1 and 322d_2 may receive commands through a corresponding CA bus among the plurality of second CA buses. For example, a (4-1)-th command decoder 322d_1 may receive commands within the (2-1)-th command/address signal CAb_1 through the pin P12d_1, and a (4-2)-th command decoder 322d_2 may receive commands within the (2-2)-th command/address signal CAb_2 through the pin P12d_2.

As illustrated, the plurality of memory devices 300_1a, 300_2a, 300_3a and 300_4a may transmit and receive the data signal DQ with the storage controller 200a via one data bus. In addition, the first and second memory devices 300_1a and 300_2a may share (1-1)-th and (1-2)-th CA buses. The first or second memory device 300_1a or 300_2a may receive (1-1)-th and (1-2)-th command/address signals CAa_1 and CAa_2 from the storage controller 200a through the (1-1)-th and (1-2)-th CA buses. The third and fourth memory devices 300_3a and 300_4a may share (2-1)-th and (2-2)-th CA buses. The third or fourth memory device 300_3a or 300_4a may receive (2-1)-th and (2-2)-th command/address signals CAb_1 and CAb_2 from the storage controller 200a through the (2-1)-th and (2-2)-th CA buses.

Although FIG. 17 illustrates that each of the plurality of memory devices 300_1b, 300_2b, 300_3b and 300_4b includes two command decoders, the disclosure is not limited thereto. For example, each of the plurality of memory devices 300_1b, 300_2b, 300_3b and 300_4b may include three or more command decoders, and each of the plurality of memory devices 300_1b, 300_2b, 300_3b and 300_4b may be connected to the storage controller 200b via three or more CA buses. In addition, although FIG. 17 illustrates that two CA buses are connected to two memory devices, a plurality of CA buses may be connected to a plurality of memory devices of any number.

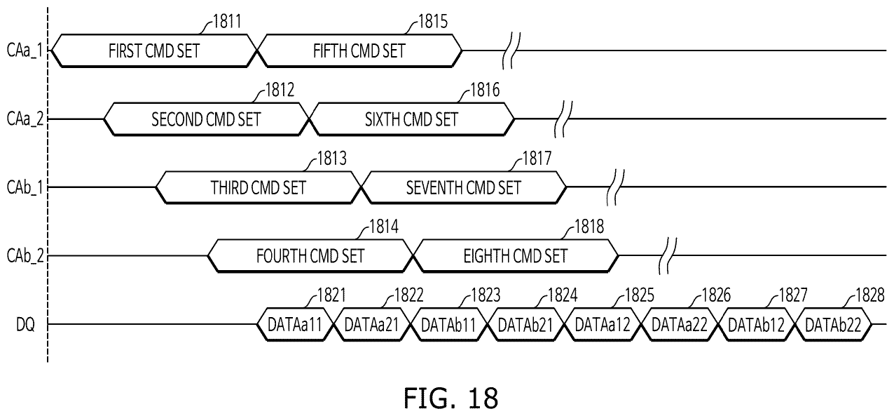

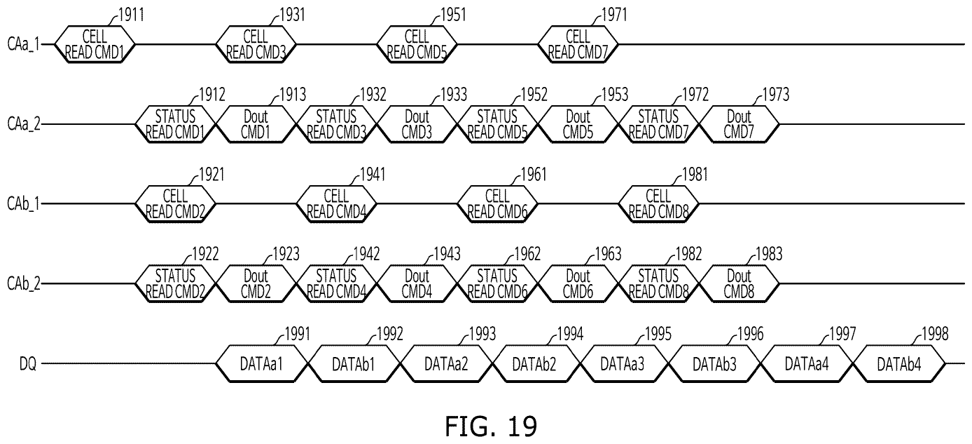

FIGS. 18 and 19 are timing diagrams illustrating various examples of command sets and data transmitted and received through the command/address and data signals of FIG. 17.

Referring to FIGS. 17 and 18, the storage controller 200b may transmit a (1-1)-th command/address signal CAa_1 through a (1-1)-th CA bus among the plurality of first CA buses, thereby transmitting a first command set 1811 to the first or second memory device 300_1b or 300_2b.

The storage controller 200b may transmit a (1-2)-th command/address signal CAa_2 through a (1-2)-th CA bus among the plurality of first CA buses, thereby transmitting a second command set 1812 to the first or second memory device 300_1b or 300_2b. The storage controller 200b may transmit in parallel such that at least a portion of the transmission time period of the first command set 1811 overlaps with at least a portion of the transmission time period of the second command set 1812.

In an embodiment, each of the first command set 1811 and the second command set 1812 may be a granularity-read command for reading, in a size smaller than a page unit, a portion of a specific page of a memory cell array in the first or second memory device 300_1b or 300_2b. For example, the first command set 1811 may include a first cell-read command, a first status-read command, and a first data-output command, and the second command set 1812 may include a second cell-read command, a second status-read command, and a second data-output command.

Each of the plurality of first command decoders 322a_1 and 322a_2 and the plurality of second command decoders 322b_1 and 322b_2 of FIG. 17 may be configured so that decoding of a cell-read command, a status-read command, and a data-output command is possible. For example, where the first memory device 300_1b receives the first and second command sets 1811 and 1812, the (1-1)-th command decoder 322a_1 may decode the first cell-read command, the first status-read command, and the first data-output command, and the (1-2)-th command decoder 322a_2 may decode the second cell-read command, the second status-read command, and the second data-output command. In another example, where the first memory device 300_1b receives the first command set 1811 and the second memory device 300_2b receives the second command set 1812, the (1-1)-th command decoder 322a_1 may decode the first cell-read command, the first status-read command, and the first data-output command, and the (2-2)-th command decoder 322b_2 may decode the second cell-read command, the second status-read command, and the second data-output command.

In another embodiment, each of the first command set 1111 and the second command set 1112 may include a plurality of commands for writing data to a portion of the memory cell array in the first or second memory device 300_1b or 300_2b.

The storage controller 200b may transmit a (2-1)-th command/address signal CAb_1 through a (2-1)-th CA bus among the plurality of second CA buses, thereby transmitting a third command set 1813 to the third or fourth memory device 300_3b or 300_4b. The storage controller 200b may transmit in parallel such that at least a portion of the transmission time period of the first command set 1811 overlaps with at least a portion of the transmission time period of the third command set 1813.

The storage controller 200b may transmit a (2-2)-th command/address signal CAb_2 through a (2-2)-th CA bus among the plurality of second CA buses, thereby transmitting a fourth command set 1814 to the third or fourth memory device 300_3b or 300_4b. The storage controller 200b may transmit in parallel such that at least a portion of the transmission time period of the third command set 1813 overlaps with at least a portion of the transmission time period of the fourth command set 1814.

In an embodiment, each of the third command set 1813 and the fourth command set 1814 may be a granularity-read command for reading, in a size smaller than a page unit, a portion of a specific page of a memory cell array in the third or fourth memory device 300_3b or 300_4b. For example, the third command set 1813 may include a third cell-read command, a third status-read command, and a third data-output command, and the fourth command set 1814 may include a fourth cell-read command, a fourth status-read command, and a fourth data-output command.

Each of the plurality of third command decoders 322c_1 and 322c_2 and the plurality of fourth command decoders 322d_1 and 322d_2 of FIG. 17 may be configured so that decoding of a cell-read command, a status-read command, and a data-output command is possible. For example, where the third memory device 300_3b receives the third and fourth command sets 1813 and 1814, the (3-1)-th command decoder 322c_1 may decode the third cell-read command, the third status-read command, and the third data-output command, and the (3-2)-th command decoder 322c_2 may decode the fourth cell-read command, the fourth status-read command, and the fourth data-output command. In another example, where the third memory device 300_3b receives the third command set 1813 and the fourth memory device 300_4b receives the fourth command set 1814, the (3-1)-th command decoder 322c_1 may decode the third cell-read command, the third status-read command, and the third data-output command, and the (4-2)-th command decoder 322d_2 may decode the fourth cell-read command, the fourth status-read command, and the fourth data-output command.

In another embodiment, each of the third command set 1113 and the fourth command set 1114 may include a plurality of commands for writing data to a portion of the memory cell array in the third or fourth memory device 300_3b or 300_4b.

The first or second memory device 300_1b or 300_2b may transmit, to the storage controller 200b, first data 1821 obtained by reading a portion of a page in the memory cell array based on the first command set 1811 and second data 1822 obtained by reading a portion of a page in the memory cell array based on the second command set 1812.

The third or fourth memory device 300_3b or 300_4b may transmit, to the storage controller 200b, third data 1823 obtained by reading a portion of a page in the memory cell array based on the third command set 1813 and fourth data 1824 obtained by reading a portion of a page in the memory cell array based on the fourth command set 1814.

Conversely, where each of the first through fourth command sets 1111, 1112, 1113 and 1114 includes a plurality of commands for writing data to a portion of the memory cell array, each of the first through fourth data 1821, 1822, 1823 and 1824 may be data to be written to the memory cell array and may be transmitted from the storage controller 200b to the first through fourth memory devices 300_1b, 300_2b, 300_3b and 300_4b.

Similarly to the operations described above, the storage controller 200b may transmit fifth through eighth command sets 1815, 1816, 1817 and 1818 to the first through fourth memory devices 300_1b, 300_2b, 300_3b and 300_4b through the plurality of first and second CA buses, and the first through fourth memory devices 300_1b, 300_2b, 300_3b and 300_4b may transmit fifth through eighth data 1825, 1826, 1827 and 1828 obtained by reading a portion of a page in the memory cell array based on the fifth through eighth command sets 1815, 1816, 1817 and 1818 to the storage controller 200b through the data bus using the data signal DQ.

Referring to FIGS. 17 and 19, the storage controller 200b may transmit first, third, fifth, and seventh cell-read commands 1911, 1931, 1951, 1971 to the first or second memory device 300_1b or 300_2b by transmitting the (1-1)-th command/address signal CAa_1 through the (1-1)-th CA bus among the plurality of first CA buses.

The storage controller 200b may transmit first and third status-read commands 1912, 1932, first and third data-output commands 1913, 1933, fifth status-read command 1952, fifth data-output command 1953, seventh status-read command 1972, and seventh data-output command 1973 to the first or second memory device 300_1b or 300_2b by transmitting the (1-2)-th command/address signal CAa_2 through the (1-2)-th CA bus among the plurality of first CA buses. The storage controller 200b may transmit in parallel such that at least a portion of the transmission time of commands transmitted through the (1-1)-th CA bus overlaps with the transmission time of commands transmitted through the (1-2)-th CA bus.

The (1-1)-th command decoder 322a_1 and the (2-1)-th command decoder 322b_1 of FIG. 17 may be configured so that decoding of cell-read commands transmitted through the (1-1)-th CA bus is possible, and the (1-2)-th command decoder 322a_2 and the (2-2)-th command decoder 322b_2 may be configured so that decoding of status-read commands and data-output commands transmitted through the (1-2)-th CA bus is possible. For example, the (1-1)-th command decoder 322a_1 or the (2-1)-th command decoder 322b_1 may decode the first, third, fifth, and seventh cell-read commands 1911, 1931, 1951, 1971, and the (1-2)-th command decoder 322a_2 or the (2-2)-th command decoder 322b_2 may decode the first and third status-read commands 1912, 1932, first and third data-output commands 1913, 1933, fifth status-read command 1952, fifth data-output command 1953, seventh status-read command 1972, and/or seventh data-output command 1973.

The storage controller 200b may transmit second, fourth, sixth, and eighth cell-read commands 1921, 1941, 1961, 1981 to the third or fourth memory device 300_3b or 300_4b by transmitting the (2-1)-th command/address signal CAb_1 through the (2-1)-th CA bus among the plurality of second CA buses.

The storage controller 200b may transmit second status-read command 1922, second data-output command 1923, fourth status-read command 1942, fourth data-output command 1943, sixth status-read command 1962, sixth data-output command 1963, eighth status-read command 1982, and/or eighth data-output command 1983 to the third or fourth memory device 300_3b or 300_4b by transmitting the (2-2)-th command/address signal CAb_2 through the (2-2)-th CA bus among the plurality of second CA buses. The storage controller 200b may transmit in parallel such that at least a portion of the transmission time of commands transmitted through the (2-1)-th CA bus overlaps with the transmission time of commands transmitted through the (2-2)-th CA bus.

The (3-1)-th and (4-1)-th command decoders 322c_1 and 322d_1 of FIG. 17 may be configured so that decoding of cell-read commands transmitted through the (2-1)-th CA bus is possible, and the (3-2)-th and (4-2)-th command decoders 322c_2 and 322d_2 may be configured so that decoding of status-read commands and data-output commands transmitted through the (2-2)-th CA bus is possible. For example, the (3-1)-th or (4-1)-th command decoder 322c_1 or 322d_1 may decode the second, fourth, sixth, and eighth cell-read commands 1921, 1941, 1961, 1981, and the (3-2)-th or (4-2)-th command decoder 322c_2 or 322d_2 may decode the second and fourth status-read commands 1922, 1942, second and fourth data-output commands 1923, 1943, sixth status-read command 1962, sixth data-output command 1963, eighth status-read command 1982, and/or eighth data-output command 1983.

The first through fourth memory devices 300_1b, 300_2b, 300_3b and 300_4b may transmit first through eighth data 1991, 1992, 1993, 1994, 1995, 1996, 1997 and 1998 obtained by reading a portion of a page in the memory cell array to the storage controller 200b.

According to the embodiment illustrated and described with reference to FIGS. 17-19, since each memory device is connected to the storage controller 200b through a plurality of command/address CA buses and each CA bus is provided with a corresponding command decoder, a plurality of command sets may be transmitted and processed in parallel. Thus, while a specific command is being transmitted to the first memory device 300_1b, another command may be overlappingly transmitted to the second memory device 300_2b through a separate CA bus, thereby improving command-processing efficiency compared with a single-CA-bus environment.

Further, even within a single memory device, different commands may be decoded simultaneously by using multiple CA buses (e.g., a cell-read command and a status-read/data-output command may be decoded in parallel), thereby reducing unnecessary command-transmission wait time and increasing overall I/O throughput. Moreover, through such a plurality of CA-bus configurations, even when the memory device operates on a sub-page basis (granularity read, etc.), commands for each memory may be input successively within a short time, thus minimizing idle time occurring during internal page-read or program operations.

The disclosure is not limited to the embodiments and the accompanying drawings described above. Various substitutions, modifications, and changes may be made by those skilled in the art without departing from the technical spirit of the disclosure, and these will also fall within the scope of the disclosure. For example, some processes described with reference to timing diagrams (e.g., FIGS. 7-9, 11-14, 16, 18, 19) may be omitted, an order and/or timing of some processes may be changed, specific processes may be temporally overlapped, or a specific process may be performed multiple times.

What is claimed is:

1. A storage device comprising:
a storage controller comprising a first data pin and a plurality of first CA pins; and
a memory device comprising a memory cell array, a second data pin connected to the first data pin via a data bus, and a plurality of second CA pins connected to the plurality of first CA pins via a plurality of CA buses,
wherein the storage controller is configured to:
transmit a first command set to the memory device via a first CA bus among the plurality of CA buses;
transmit a second command set to the memory device via a second CA bus among the plurality of CA buses; and
transmit, in parallel, at least a portion of the first command set and at least a portion of the second command set so that transmission periods of the at least portions of the first command set and the second command set overlap with each other.

2. The storage device according to claim 1,
wherein the first command set and the second command set comprise a plurality of commands for reading a portion of the memory cell array.

3. The storage device according to claim 2,
wherein the memory cell array comprises a memory block comprising a plurality of pages,
each of the plurality of pages comprises a plurality of memory cells connected to word lines, and
each of the plurality of commands is a granularity read command configured to read a portion smaller than a page unit from one of the plurality of pages.

4. The storage device according to claim 3, wherein the memory device is configured to:
obtain first data by reading a portion of a first page among the plurality of pages based on the first command set;
transmit the first data to the storage controller;
obtain second data by reading a portion of a second page among the plurality of pages based on the second command set; and
transmit the second data to the storage controller.

5. The storage device according to claim 4,
wherein the storage controller is further configured to:
transmit the first command set at a first point in time; and
transmit the second command set at a second point in time that is after a first duration has elapsed from the first point in time, and
wherein a second duration, which is a transmission period of the first data, is equal to or greater than the first duration.

6. The storage device according to claim 1,
wherein the first command set and the second command set comprise a plurality of commands for writing data to a portion of the memory cell array.

7. The storage device according to claim 1, wherein the storage controller is further configured to:
transmit a third command set to the memory device via a third CA bus among the plurality of CA buses; and
transmit, in parallel, at least a portion of the second command set and at least a portion of the third command set so that transmission periods of the at least potions of the second command set and the third command set overlap with each other.

8. The storage device according to claim 7,
wherein the storage controller is configured to:
transmit the first command set at a first point in time;
transmit the second command set at a second point in time after a first duration has elapsed from the first point in time; and
transmit the third command set at a third point in time after a second duration has elapsed from the second point in time,
wherein the memory device is further configured to:
transmit first data obtained by reading a portion of a first page among the plurality of pages based on the first command set to the storage controller;
transmit second data obtained by reading a portion of a second page among the plurality of pages based on the second command set to the storage controller; and
transmit third data obtained by reading a portion of a third page among the plurality of pages based on the third command set to the storage controller,
wherein a third duration, which is a transmission period of the first data, is equal to or greater than the first duration, and
wherein a fourth duration, which is a transmission period of the second data, is equal to or greater than the second duration.

9. The storage device according to claim 1,
wherein the memory device comprises a plurality of command decoders configured to decode commands received via the plurality of CA buses, each of the plurality of command decoders being configured to receive commands via a corresponding CA bus among the plurality of CA buses.

10. The storage device according to claim 9,
wherein the plurality of command decoders comprises:
a first command decoder configured to receive commands via the first CA bus; and
a second command decoder configured to receive commands via the second CA bus,
wherein the first command set comprises a first cell read command, a first status read command, and a first data output command,
wherein the second command set comprises a second cell read command, a second status read command, and a second data output command,
wherein the first command decoder is configured to decode the first cell read command, the first status read command, and the first data output command, and
wherein the second command decoder is configured to decode the second cell read command, the second status read command, and the second data output command.

11. The storage device according to claim 9,
wherein the plurality of command decoders comprises:
a first command decoder connected to the first CA bus; and
a second command decoder connected to the second CA bus,
wherein the first command set comprises a first cell read command and a second cell read command,
wherein the second command set comprises a first status read command, a first data output command, a second status read command, and a second data output command,
wherein the first command decoder is configured to decode the first cell read command and the second cell read command, and
wherein the second command decoder is configured to decode the first status read command, the first data output command, the second status read command, and the second data output command.

12. The storage device according to claim 9,
wherein the storage controller is further configured to:
transmit a third command set to the memory device via a third CA bus among the plurality of CA buses; and
transmit, in parallel, at least a portion of the second command set and at least a portion of the third command set so that transmission periods of the at least portions of the second command set and the third command set overlap with each other,
wherein the first command set comprises a first cell read command, a second cell read command, and a third cell read command,
wherein the second command set comprises a first status read command, a second status read command, and a third status read command,
wherein the third command set comprises a first data output command, a second data output command, and a third data output command, and
wherein the plurality of command decoders comprises:
a first command decoder configured to receive via the first CA bus and decode the first cell read command, the second cell read command, and the third cell read command;
a second command decoder configured to receive via the second CA bus and decode the first status read command, the second status read command, and the third status read command; and
a third command decoder configured to receive and decode the first data output command, the second data output command, and the third data output command via the third CA bus.

13. A storage device comprising:
a storage controller;
a first memory device comprising a first memory cell array, the first memory device being connected to the storage controller via a data bus and a plurality of first CA buses; and
a second memory device comprising a second memory cell array, the second memory device being connected to the storage controller via the data bus and a plurality of second CA buses,
wherein the storage controller is configured to:
transmit a first command set to the first memory device via a (1-1)-th CA bus among the plurality of first CA buses;
transmit a second command set to the first memory device via a (1-2)-th CA bus among the plurality of first CA buses;
transmit, in parallel, at least a portion of the first command set and at least a portion of the second command set so that transmission periods of the at least portions of the first command set and the second command set overlap with each other;
transmit a third command set to the second memory device via a (2-1)-th CA bus among the plurality of second CA buses;
transmit, in parallel, at least a portion of the first command set and at least a portion of the third command set so that transmission periods of the at least portions of the first command set and the third command set overlap with each other;
transmit a fourth command set to the second memory device via a (2-2)-th CA bus among the plurality of second CA buses; and
transmit, in parallel, at least a portion of the third command set and at least a portion of the fourth command set so that transmission periods of the at least portions of the third command set and the fourth command set overlap with each other.

14. The storage device according to claim 13,
wherein the first memory cell array comprises a first memory block comprising a first page and a second page,
wherein the second memory cell array comprises a second memory block comprising a third page and a fourth page,
wherein the first command set is a granularity read command for reading a portion of the first page smaller than a page unit,
wherein the second command set is a granularity read command for reading a portion of the second page smaller than a page unit,
wherein the third command set is a granularity read command for reading a portion of the third page smaller than a page unit, and
wherein the fourth command set is a granularity read command for reading a portion of the fourth page smaller than a page unit.

15. The storage device according to claim 14,
wherein the first memory device is configured to:
transmit first data obtained by reading a portion of the first page based on the first command set to the storage controller; and
transmit second data obtained by reading a portion of the second page based on the second command set to the storage controller, and
wherein the second memory device is configured to:
transmit third data obtained by reading a portion of the third page based on the third command set to the storage controller; and
transmit fourth data obtained by reading a portion of the fourth page based on the fourth command set to the storage controller.

16. The storage device according to claim 13,
wherein the first memory device comprises a plurality of first command decoders configured to decode commands received via the plurality of first CA buses, each of the plurality of first command decoders being configured to receive commands via a corresponding CA bus among the plurality of first CA buses,
wherein the second memory device comprises a plurality of second command decoders configured to decode commands received via the plurality of second CA buses, and
wherein each of the plurality of second command decoders being configured to receive commands via a corresponding CA bus among the plurality of second CA buses.

17. The storage device according to claim 16,
wherein the first command set comprises a first cell read command, a first status read command, and a first data output command,
wherein the second command set comprises a second cell read command, a second status read command, and a second data output command,
wherein the third command set comprises a third cell read command, a third status read command, and a third data output command, and
wherein the fourth command set comprises a fourth cell read command, a fourth status read command, and a fourth data output command.

18. The storage device according to claim 17,
wherein a (1-1)-th command decoder among the plurality of first command decoders is configured to decode the first cell read command, the first status read command, and the first data output command,
wherein a (1-2)-th command decoder among the plurality of first command decoders is configured to decode the second cell read command, the second status read command, and the second data output command,
wherein a (2-1)-th command decoder among the plurality of second command decoders is configured to decode the third cell read command, the third status read command, and the third data output command, and
wherein a (2-2)-th command decoder among the plurality of second command decoders is configured to decode the fourth cell read command, the fourth status read command, and the fourth data output command.

19. The storage device according to claim 16,
wherein the first command set comprises a first cell read command and a second cell read command,
wherein the second command set comprises a first status read command, a first data output command, a second status read command, and a second data output command,
wherein the third command set comprises a third cell read command and a fourth cell read command,
wherein the fourth command set comprises a third status read command, a third data output command, a fourth status read command, and a fourth data output command,
wherein a (1-1)-th command decoder among the plurality of first command decoders is configured to decode the first cell read command and the second cell read command,
wherein a (1-2)-th command decoder among the plurality of first command decoders is configured to decode the first status read command, the first data output command, the second status read command, and the second data output command,
wherein a (3-1)-th command decoder among the plurality of third command decoders is configured to decode the third cell read command and the fourth cell read command, and
wherein a (3-2)-th command decoder among the plurality of third command decoders is configured to decode the third status read command, the third data output command, the fourth status read command, and the fourth data output command.

20. A storage device comprising:
a storage controller comprising a first data pin and a plurality of first CA pins; and
a memory device comprising a memory cell array comprising a plurality of pages comprising a plurality of memory cells connected to word lines, a second data pin connected to the first data pin via a data bus, and a plurality of second CA pins connected to the plurality of first CA pins via a plurality of CA buses,
wherein the storage controller is configured to:
transmit, via a first CA bus among the plurality of CA buses, a first command set comprising a plurality of granularity commands configured to read a portion of a first page among the plurality of pages smaller than a page unit; and
transmit, via a second CA bus among the plurality of CA buses, a second command set comprising a plurality of granularity commands configured to read a portion of a second page among the plurality of pages smaller than a page unit, and
transmit, in parallel, at least portions of the first command set and the second command set so that transmission periods of the at least portions of the first command set and the second command set overlap with each other,
wherein the memory device comprises:
a first command decoder configured to receive and decode commands via the first CA bus; and
a second command decoder configured to receive and decode commands via the second CA bus, and
wherein the memory device is further configured to:
transmit, to the storage controller, first data obtained by reading the portion of the first page among the plurality of pages based on the first command set, and
transmit, to the storage controller, second data obtained by reading the portion of the second page among the plurality of pages based on the second command set.
